(19) United States
(12) Patent Application Publication
(10) Pub. No.: US 2026/0252607 A1
(43) Pub. Date: Aug. 27, 2026

(54) Transformer-Based Assistant for Identifying, Organizing, and Responding to Customer Concerns

(71) Applicant: Ujwal Inc., Mountain View, CA (US)

(72) Inventors: Abhimanyu Talwar, Mississauga (CA); Manisha Barnwal, New Orleans, LA (US); Dhruv Mullick, Delhi (IN); Ashish Nagar, Los Altos, CA (US); Shreyansh Singh, Noida (IN)

(21) Appl. No.: 19/643,725

(22) Filed: Apr. 9, 2026

Related U.S. Application Data
(63) Continuation of application No. PCT/US24/55312, filed on Nov. 11, 2024.
(60) Provisional application No. 63/597,343, filed on Nov. 9, 2023.

(51) Int. Cl. G06F 16/334; G06F 16/34; G06F 16/35; G06N 3/0455

(52) U.S. Cl. CPC G06F 16/334; G06F 16/345; G06F 16/35; G06N 3/0455

(57) ABSTRACT

Transformer-based agent assistant systems as machine learning-based customer service tools that analyze past customer-agent conversations to build a knowledge base of problem-resolution steps are disclosed. The system may include a natural language processing (NLP) model and a transformer-based model to extract and generate customer concerns and resolutions. One embodiment also includes a head-topic and subtopic detection module for identifying trends in customer concerns. Another embodiment uses a question-answering model and a zero-shot-NLI (natural language inference) classifier for entity extraction and detection. The system is designed to be flexible, incorporating new data over time, and can retrieve company documentation or FAQs for the agent based on cosine similarity.

### REFERENCE TO RELATED APPLICATIONS

This application is related to the U.S. patent applications listed below, which are incorporated by reference in their entireties herein, as if fully set forth herein:

U.S. provisional patent application No. 63/442,159 (Docket No. LEV-1002P), filed on 31 Jan. 2023, entitled “Configurable Intent Phrase Based Quality Assurance Systems,” describing semantic similarity-based configurable systems for automatic scenario detection in customer-agent conversations.

U.S. provisional patent application No. 63/521,105 (Docket No. LEV-1001P), filed on 15 Jun. 2023, entitled “Customer Agent Screen Recording Systems and Methods,” describing methods for triggered recording and analysis of customer-agent interactions using a customer relationship management (CRM) system.

U.S. provisional patent application No. 63/597,343 (Docket No. LEV-1003P), filed on 9 Nov. 2023, entitled “Transformer-Based Assistant for Identifying, Organizing, and Responding to Customer Concerns,” describing transformer-based agent assistant systems that serve as machine learning-based customer service tools that analyze past customer-agent conversations to build knowledge bases of problem-resolution steps.

PCT patent application No. PCT/US 24/13558 (Docket No. LEV-1002PCT), filed on 30 Jan. 2024, entitled “Quality Assurance Systems Based on Speaker Intent Detection,” describing semantic similarity-based configurable systems for automatic scenario detection in customer-agent conversations.

PCT patent application No. PCT/US 24/34187 (Docket No. LEV-1001PCT), filed on 14 Jun. 2024, entitled “Customer Agent Recording Systems and Methods,” describing methods for triggered recording and analysis of customer-agent interactions using a customer relationship management (CRM) system.

PCT patent application No. PCT/US 24/55312 (Docket No. LEV-1003PCT), filed on 11 Nov. 2024, entitled “Transformer-Based Assistant for Identifying, Organizing, and Responding to Customer Concerns,” describing transformer-based agent assistant systems that serve as machine learning-based customer service tools that analyze past customer-agent conversations to build knowledge bases of problem-resolution steps.

### FIELD OF THE INVENTION

This disclosure relates to machine learning tools used to assist human customer support agents.

### BACKGROUND OF THE INVENTION

The statements in the background of the invention are provided to assist with understanding the invention and its applications and uses, and may not constitute prior art.

All the conversations that happen at a contact center between a human customer support agent of a company and a customer are mostly unstructured. There may be a series of questions that the agent is trained to ask, but natural conversations, especially between a frustrated customer and an agent, often lacks any such formal structure. Determining the exact concern or grievance of the customer who is calling is crucial for the product teams at the company. If they obtain real-time information about the problems the customers are facing, and know which products the concerns are associated with, the information can help them stay on top of all these issues and roll out solutions as quickly as possible. The problems can be diverse: software bugs, delivery delays, clunky product user interfaces, and so on. Each problem may be of varying severity levels, but identifying the core issues directly from the raw conversations, may help a company assign a responsible team to resolve any recurring and pressing issues.

It is against this background that the present invention was developed.

### BRIEF SUMMARY OF THE INVENTION

This summary of the invention provides a broad overview of the invention, its application, and uses, and is not intended to limit the scope of the present invention, which will be apparent from the detailed description when read in conjunction with the drawings.

Accordingly, in view of the background, it would be an advancement in the state of the art to develop a system that auto-curates a knowledge base of customer concern and agent resolution pairs, and uses this knowledge base for (1) speeding up agents'response time, (2) speeding up new agents'onboarding time, and (3) discovering meaningful clusters of customers'grievances so that they can be addressed early. A strength of such a system is that unlike most state-of-the-art systems, which rely on curated knowledge bases to answer questions, the disclosed system may mine through many (e.g., thousands) of past conversations to find answers to questions which aren't present in any knowledge base.

As used herein, a “human agent” or merely “agent” is, for example, a human customer support agent in a call center. This is to be contrasted with an alternative use of the word “agent” for software or AI agents, for example, software agents that assist the human agent. The meaning of the term would be clear from its use in context.

According to a first aspect or in one embodiment, a computer-implemented method for generating a set of recommended steps for concern resolution is provided. The method may comprise collecting a plurality of conversations between customers and human agents. Each conversation in the plurality of conversations between customers and human agents may comprise at least one concern, at least one agent utterance, and at least one resolution step. The method may comprise training a transformer-based system on the plurality of conversations between customers and human agents to build a concern-resolution steps knowledge base. The transformer-based system may comprise a bidirectional encoder and an autoregressive decoder. The method may comprise receiving a human agent input through a human agent interface. Finally, the method may comprise generating the set of recommended steps for concern resolution based on the human agent input. The set of recommended steps for concern resolution may be retrieved from the concern-resolution steps knowledge base.

In one embodiment, the method may further comprise integrating a set of frequently asked questions (FAQs) and answers into the concern-resolution steps knowledge base. The method may further comprise making the knowledge base searchable for a human agent to search through past resolutions to any customer concern that is input as a query.

In one embodiment, the transformer-based system further comprises a sequence-to-sequence model. Training the transformer-based system comprises fine-tuning based on a plurality of extracted concerns from the plurality of conversations.

In one embodiment, the method may further comprise extracting the at least one concern from a conversation in the plurality of conversations between customers and human agents using the transformer-based system to generate an extracted concern. The method may further comprise extracting the at least one agent utterance from the conversation in the plurality of conversations between customers and human agents using the transformer-based system to generate an extracted utterance. The method may further comprise extracting the at least one resolution step from the conversation in the plurality of conversations between customers and human agents using the transformer-based system to generate an extracted resolution step. Finally, the method may further comprise storing a database entry comprising the extracted concern, the extracted utterance, and the extracted resolution step into the concern-resolution steps knowledge base.

In one embodiment, the method may further comprise using a retrieve-rerank process to generate the set of recommended steps for concern resolution. The retrieve-rerank process may comprise embedding the human agent input to generate an embedding of the human agent input. The retrieve-rerank process may further comprise embedding a first plurality of resolution steps in the concern-resolution steps knowledge base to generate a first plurality of embeddings of resolution steps. The retrieve-rerank process may further comprise determining a cosine-similarity score between each embedding of resolution steps in the first plurality of embeddings of resolution steps and the embedding of the human agent input to generate a first plurality of cosine-similarity scores. The retrieve-rerank process may further comprise determining a plurality of closest resolution steps based on the highest cosine-similarity scores in the plurality of cosine-similarity scores. The plurality of closest resolution steps may correspond to a second plurality of embeddings of resolution steps in the first plurality of embeddings of resolution steps. The retrieve-rerank process may further comprise embedding a first plurality of concerns in the concern-resolution steps knowledge base to generate a first plurality of embeddings of concerns. The retrieve-rerank process may further comprise determining a cosine-similarity score between each embedding of concerns in the first plurality of embeddings of concerns and the embedding of the human agent input to generate a second plurality of cosine-similarity scores. Finally, the retrieve-rerank process may further comprise reranking the plurality of closest resolution steps to generate the set of recommended steps for concern resolution. Reranking the plurality of closest resolution steps may be based on the second plurality of cosine-similarity scores.

In one embodiment, the method may further comprise displaying official company internal documentation articles and/or FAQs to the human agent. The method may further comprise preparing a knowledge base of each summarized article and FAQ answer and corresponding embeddings.

In one embodiment, the method may further comprise generating a plurality of head entities from the concern-resolution steps knowledge base using a head topic and subtopic detection module. The method may further comprise determining a plurality of closest head entities from the plurality of head entities corresponding to the set of recommended steps for concern resolution based on measuring the match between each head entity in the plurality of head entities with each recommended step for concern resolution in the set of recommended steps for concern resolution. The method may further comprise receiving, by the bidirectional encoder, the set of recommended steps for concern resolution and the plurality of closest head entities from the plurality of head entities corresponding to the set of recommended steps. Finally, the method may further comprise generating, by the bidirectional encoder, a plurality of subtopics associated with the plurality of closest head entities. The plurality of subtopics may be correlated with the set of recommended steps for concern resolution. A correlation between the plurality of subtopics and the set of recommended steps for concern resolution may be based on a semantic cosine similarity.

In one embodiment, generating the set of recommended steps for concern resolution based on the human agent input uses a concern model. The concern model may comprise a conversation truncation module, a transformer, a concern-resolution steps knowledge base, and an encoder-decoder module. The concern model may be configured to be trained by minimizing the cross-entropy loss.

In one embodiment, the method may further comprise using a head topic detection system to obtain answers. The method may further comprise passing the answers through a hierarchical clustering algorithm that uses the word level edit distance between the spans as a distance metric.

In one embodiment, the method may further comprise using a zero-shot-NLI (natural language inference) classifier to detect the entity that represents the main entity in the concern. The method may further comprise performing a semantic cosine similarity of the concern and the centroid embedding of the sub-topics. The method may further comprise identifying a closest sub-topic above a threshold within the head topic to which the concern belongs.

According to a second or in another embodiment, a non-transitory physical storage media storing program code is provided. The program code is executable by a hardware processor. The hardware processor when executing the program code causes the hardware processor to execute a computer-implemented process for generating automated recommended steps for concern resolution. The program code comprises code that may collect a plurality of conversations between customers and human agents. Each conversation in the plurality of conversations between customers and human agents may comprise at least one concern, at least one agent utterance, and at least one resolution step. The program code may comprise code to train a transformer-based system on the plurality of conversations between customers and human agents to build a concern-resolution steps knowledge base, wherein the transformer-based system comprises a bidirectional encoder and an autoregressive decoder. The program code may comprise code to receive a human agent input through a human agent interface. Finally, the program code may comprise code to generate the set of recommended steps for concern resolution based on the human agent input. The set of recommended steps for concern resolution may be retrieved from the concern-resolution steps knowledge base.

In one embodiment, the program code may further comprise code to integrate a set of frequently asked questions (FAQs) and answers into the concern-resolution steps knowledge base. The program code may further comprise code to make the knowledge base searchable for a human agent to search through past resolutions to any customer concern that is input as a query.

In one embodiment, the transformer-based system may further comprise a sequence-to-sequence model. The program code to train the transformer-based system may comprise program code to fine-tune based on a plurality of extracted concerns from the plurality of conversations.

In one embodiment, the program code may further comprise code to extract the at least one concern from a conversation in the plurality of conversations between customers and human agents using the transformer-based system to generate an extracted concern. The program code may further comprise code to extract the at least one agent utterance from the conversation in the plurality of conversations between customers and human agents using the transformer-based system to generate an extracted utterance. The program code may further comprise code to extract the at least one resolution step from the conversation in the plurality of conversations between customers and human agents using the transformer-based system to generate an extracted resolution step. Finally, the program code may further comprise code to store a database entry comprising the extracted concern, the extracted utterance, and the extracted resolution step into the concern-resolution steps knowledge base.

In one embodiment, the program code may further comprise code to use a retrieve-rerank process to generate the set of recommended steps for concern resolution. The program code for the retrieve-rerank process may comprise program code to embed the human agent input to generate an embedding of the human agent input. The retrieve-rerank program code may further comprise program code to embed a first plurality of resolution steps in the concern-resolution steps knowledge base to generate a first plurality of embeddings of resolution steps. The retrieve-rerank program code may further comprise program code to determine a cosine-similarity score between each embedding of resolution steps in the first plurality of embeddings of resolution steps and the embedding of the human agent input to generate a first plurality of cosine-similarity scores. The retrieve-rerank program code may further comprise program code to determine a plurality of closest resolution steps based on the highest cosine-similarity scores in the plurality of cosine-similarity scores. The plurality of closest resolution steps may correspond to a second plurality of embeddings of resolution steps in the first plurality of embeddings of resolution steps. The retrieve-rerank program code may further comprise program code to embed a first plurality of concerns in the concern-resolution steps knowledge base to generate a first plurality of embeddings of concerns. The retrieve-rerank program code may further comprise program code to determine a cosine-similarity score between each embedding of concerns in the first plurality of embeddings of concerns and the embedding of the human agent input to generate a second plurality of cosine-similarity scores. Finally, the retrieve-rerank program code may further comprise program code to rerank the plurality of closest resolution steps to generate the set of recommended steps for concern resolution. Reranking the plurality of closest resolution steps may be based on the second plurality of cosine-similarity scores.

In one embodiment, the program code may further comprise code to display official company internal documentation articles and/or FAQs to the human agent. The program code may further comprise code to prepare a knowledge base of each summarized article and FAQ answer and corresponding embeddings.

In one embodiment, the program code may further comprise code to generate a plurality of head entities from the concern-resolution steps knowledge base using a head topic and subtopic detection module. The program code may further comprise code to determine a plurality of closest head entities from the plurality of head entities corresponding to the set of recommended steps for concern resolution based on measuring the match between each head entity in the plurality of head entities with each recommended step for concern resolution in the set of recommended steps for concern resolution. The program code may further comprise code to receive, by the bidirectional encoder, the set of recommended steps for concern resolution and the plurality of closest head entities from the plurality of head entities corresponding to the set of recommended steps. Finally, the program code may further comprise code to generate, by the bidirectional encoder, a plurality of subtopics associated with the plurality of closest head entities. The plurality of subtopics may be correlated with the set of recommended steps for concern resolution. A correlation between the plurality of subtopics and the set of recommended steps for concern resolution may be based on a semantic cosine similarity.

In one embodiment, the program code to generate the set of recommended steps for concern resolution based on the human agent input utilizes a concern model. The concern model may comprise a conversation truncation module, a transformer, a concern-resolution steps knowledge base, and an encoder-decoder module. The concern model may be configured to be trained by minimizing the cross-entropy loss.

In one embodiment, the program code may further comprise code to use a head topic detection system to obtain answers. The program code may further comprise code to pass the answers through a hierarchical clustering algorithm that uses the word level edit distance between the spans as a distance metric.

In one embodiment, the program code may further comprise code to use a zero-shot-NLI (natural language inference) classifier to detect the entity that represents the main entity in the concern. The program code may further comprise code to perform a semantic cosine similarity of the concern and the centroid embedding of the sub-topics. The program code may further comprise code to identify a closest sub-topic above a threshold within the head topic to which the concern belongs.

In various embodiments, a computer program product is disclosed. The computer program product may be used for concern mining, and may include a computer-readable storage medium having program instructions, or program code, embodied therewith, the program instructions executable by a processor to cause the processor to perform steps described herein.

In various embodiments, a system is described, including a memory that stores computer-executable components, and a hardware processor, operably coupled to the memory, and that executes the computer-executable components stored in the memory, wherein the computer-executable components may include components communicatively coupled with the processor that execute the steps described herein.

In another embodiment, the present invention is a non-transitory, computer-readable storage medium storing executable instructions, which when executed by a processor, causes the processor to perform a process for concern mining, the instructions causing the processor to perform the steps described herein.

In another embodiment, the present invention is a system for concern mining, as shown and described herein, the system comprising a user device having a processor, a display, a first memory; a server comprising a second memory and a data repository; a telecommunications-link between said user device and said server; and a plurality of computer codes embodied on said first and second memory of said user-device and said server, said plurality of computer codes which when executed causes said server and said user-device to execute a process comprising the steps described herein.

In yet another embodiment, the present invention is a computerized server comprising at least one processor, memory, and a plurality of computer codes embodied on said memory, said plurality of computer codes which when executed causes said processor to execute a process comprising the aforementioned steps. Other aspects and embodiments of the present invention include the methods, processes, and algorithms comprising the steps described herein, and also include the processes and modes of operation of the systems and servers described herein.

Yet other aspects and embodiments of the present invention will become apparent from the detailed description of the invention when read in conjunction with the attached drawings.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. For clarity, simplicity, and flexibility, not all elements, components, or specifications are defined in all drawings. Not all drawings corresponding to specific steps or embodiments of the present invention are drawn to scale. Emphasis is instead placed on illustration of the nature, function, and product of the manufacturing method and devices described herein.

Embodiments of the present invention described herein are exemplary, and not restrictive. Embodiments will now be described, by way of examples, with reference to the accompanying drawings, in which:

FIG. 1 shows an example diagram of a transformer-based agent assistant system, in accordance with the examples disclosed herein.

FIG. 2 shows an example concern theme flow, in accordance with the examples disclosed herein.

FIG. 3 shows an example head-topic and sub-topic detection pipeline diagram, in accordance with the examples disclosed herein.

FIG. 4 shows an example concern model training diagram, in accordance with the examples disclosed herein.

FIG. 5 shows an example concern model inference diagram, in accordance with the examples disclosed herein.

FIG. 6 shows an example resolution model training diagram, in accordance with the examples disclosed herein.

FIG. 7 shows an example resolution model inference diagram, in accordance with the examples disclosed herein.

FIG. 8 shows an example encoder-decoder architecture diagram, in accordance with the examples disclosed herein.

FIG. 9 shows an example block diagram of a bi-encoder, in accordance with the examples disclosed herein.

FIG. 10 shows an example block diagram of a cross-encoder, in accordance with the examples disclosed herein.

FIG. 11 shows a flow diagram detailing the operation of a transformer-based agent assistant system, in accordance with the examples disclosed herein.

FIG. 12 shows yet another flow diagram detailing the operation of a transformer-based agent assistant system, in accordance with the examples disclosed herein.

FIG. 13 shows a system diagram illustrating a transformer-based agent assistant system, in accordance with the examples disclosed herein.

FIG. 14 describes fundamental neural network operation as it relates to a transformer-based agent assistant system, according to exemplary embodiments of the present invention.

FIG. 15 shows an overview of the neural network training process that can be used in a transformer-based agent assistant system, according to exemplary embodiments of the present invention.

FIG. 16 is an illustrative flow diagram showing the different phases and datasets involved in training a machine learning algorithm for a transformer-based agent assistant system, according to exemplary embodiments of the present invention.

FIG. 17 provides illustrative schematics of a server (management computing entity) and a client (user computing entity) used for a transformer-based agent assistant system, according to some embodiments of the present invention.

### DETAILED DESCRIPTION OF THE INVENTION

In the following description, for purposes of explanation, numerous specific details are set forth in order to provide a thorough understanding of the invention. It will be apparent, however, to one skilled in the art that the invention can be practiced without these specific details. In other instances, structures, devices, activities, methods, and processes are shown using schematics, use cases, and/or diagrams in order to avoid obscuring the invention. Although the following description contains many specifics for the purposes of illustration, anyone skilled in the art will appreciate that many variations and/or alterations to suggested details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

### AgentGPT System

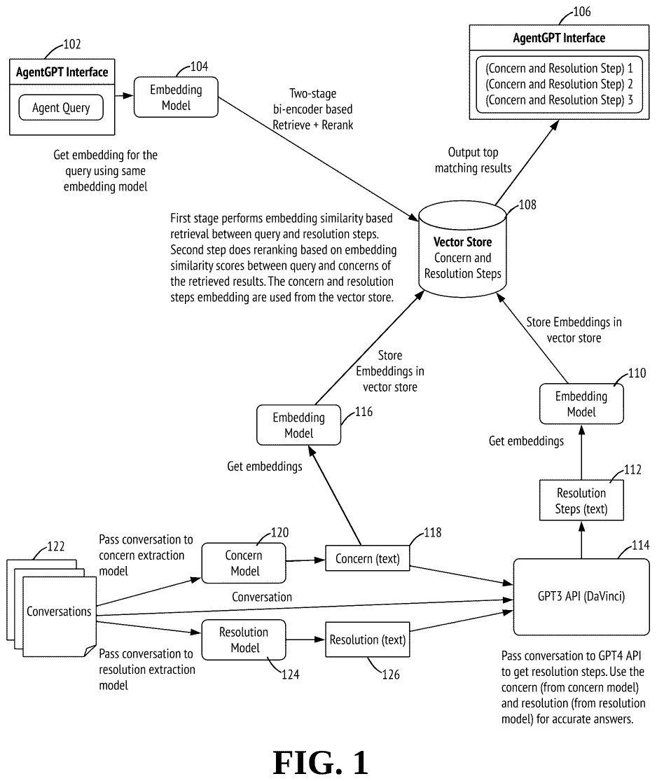

FIG. 1 shows an example diagram of a transformer-based agent assistant system, in accordance with the examples disclosed herein. While some embodiments may include a generative pre-trained transformer (GPT), other embodiments may not. As used herein, “AgentGPT” refers to any transformer-based agent assistant. Although the disclosure may refer to specific architecture for GPT systems, embodiments that generalize to transformer-based systems that are not based on GPTs would be apparent to those skilled in the art. In some embodiments, GPT-based models are employed in one-off data preparation for the pipeline even when ultimate models are based on non-GPT transformer-based architectures.

The schematic illustrates a system architecture for processing and retrieving information from conversations. It shows multiple components and their interactions, centered around an AgentGPT interface 102 and a vector store 108 for concerns and resolution steps. The system begins with “conversations” 122 as input, which are processed through three main paths: a “concern model” 120, a “resolution model” 124, and directly to a transformer 114 (e.g., “GPT3 API (DaVinci)”). The concern model 120 and resolution model 124 extract text from the conversations, to generate a concern (text) 118 and a resolution (text) 126, respectively. The concern (text) 118 is then embedded using an embedding model 116. These embeddings are stored in the vector store 108. Resolution steps (112) from the transformer 114 are embedded using another embedding model 110 and stored in vector store 108. On the query side, the AgentGPT interface 102 receives an agent query, which is processed through an embedding model 104. This query embedding is used in a two-stage bi-encoder based retrieve-rerank process to search the vector store 108. The system outputs top matching results, consisting of concerns and resolution steps, back to the AgentGPT interface 106. The schematic also shows how the GPT3 API interacts with the concern and resolution information to generate accurate answers. Overall, the diagram represents a natural language processing and information retrieval system designed to handle and respond to queries based on conversation data. In some embodiments, the process employs a large language model (LLM), such as GPT, to extract concern, resolution, and resolution steps. A model (e.g., encoder-decoder) is trained for concerns and resolution, and another model (e.g., longformer) is trained for resolution steps. Training is performed on a large number (e.g., 20,000 to 30,000) conversations. The data is stored in a database, and the set of best resolution steps based on the agent's input is retrieved.

In some embodiments, the AgentGPT system is trained on actual conversations between customers and agents to build a concern-resolution steps knowledge base (KB), which may then be accessed by a user inputting an agent query through an AgentGPT interface to generate a set of automated recommended steps to be taken by the user. In addition to the customer concerns, the resolution steps that an agent suggests in a call are another key component of the conversation. Identifying and extracting concrete resolution steps and pairing them with the concerns contributes to the knowledge base, which any new agent may then use to ramp up quickly and handle all sorts of problems that their customers may be facing. Also, if the company has a set of internal (or external) FAQs (Frequently Asked Questions) and answers, then these may be integrated into the knowledge base as well. Making this knowledge base searchable allows any agent to use the tool to search through all sorts of past resolutions to any customer concern that is input as a query.

In some embodiments, the AgentGPT system comprises several components: a concern model, a resolution model, an embedding model, and a vector store. In some embodiments, the AgentGPT system uses a seq2seq (sequence-to-sequence) NLP model. The model will take in the conversation or the first half of it (in case the conversation is very long) as input and give the customer concern as the output. A key ingredient for training such a model is a dataset of conversations and corresponding customer concerns. In some embodiments, the concern model is a Bidirectional and Auto-Regressive Transformers (BART)-based model (encoder-decoder) trained on human annotated conversation-concern pairs, or pairs generated by a larger transformer model (e.g., a Curie model), where the input is a conversation (e.g., in text format) and the output is a concern (e.g., in text format). BART is a transformer encoder-decoder (seq2seq) model with a bidirectional (BERT-like) encoder and an autoregressive (GPT-like) decoder. Advantages of the BART model includes high performance and lightweight structure. In some embodiments, the resolution model is a BART-based model (encoder-decoder) trained on human annotated conversation-concern pairs, or pairs generated by a larger transformer model (e.g., a Curie model), where the input is a conversation (e.g., in text format) and the output is a resolution (e.g., in text format). The BART-based model used in the AgentGPT system represents a powerful and efficient approach to extracting concerns and resolutions from conversations. BART combines the strengths of BERT's bidirectional encoder and GPT's autoregressive decoder, making it well-suited for sequence-to-sequence tasks such as conversation analysis.

In the context of concern extraction, the BART model may be trained on a dataset of conversation-concern pairs. These pairs may be human-annotated, ensuring high-quality training data. Alternatively, to scale up the training data generation process, a larger transformer model such as GPT-3ss Curie model may be used to generate synthetic conversation-concern pairs. This approach allows for the creation of a large, diverse dataset that covers a wide range of potential customer concerns. The input to the BART model is a conversation in text format. This may include the full conversation transcript or a truncated version focusing on the initial portion where concerns are typically expressed. The model processes this input through its bidirectional encoder, which allows it to consider the full context of the conversation when identifying the concern. The output of the BART model is the extracted concern, also in text format. This concern represents a concise summary of the customer's issue or query, distilled from the broader conversation. The autoregressive decoder generates this output token by token, leveraging the full encoded context of the input conversation.

In some implementations, the BART model may be further fine-tuned on domain-specific data to enhance its performance for particular industries or types of customer interactions. This fine-tuning process may allow the model to better understand industry-specific terminology and common concerns or resolutions unique to certain business sectors. The BART-based models may also benefit from transfer learning, leveraging knowledge gained from pre-training on large corpora of text. This pre-training may help the models develop a robust understanding of language structure and semantics, which can then be applied to the specific tasks of concern and resolution extraction.

To enhance the model's performance, techniques such as data augmentation may be employed during training. This could involve creating variations of the training data by applying transformations such as synonym replacement, back-translation, or inserting and deleting words. Such augmentation may help the model become more robust to variations in language and conversation structure.

In some cases, the BART model may be combined with other techniques to further improve its performance. For example, a retrieval-augmented generation approach could be used, where relevant information from a knowledge base is retrieved based on the conversation context and provided to the BART model as additional input. This could help the model generate more informed and accurate concerns and resolutions.

In some embodiments, the embedding model is a pre-trained encoder model, where the input is a conversation (e.g., in text format) and the output is an embedding (e.g., embedding vector). This is a general purpose embedding model that works well out of the box.

In some embodiments, the vector store 108 is a vector database that stores embeddings with corresponding IDs. In some embodiments, there are two separate vector stores, one for concerns and one for resolution steps. When an embedding from an agent's query is received, using a two-stage bi-encoder-based retrieve and rerank process, a suitable concern and resolution step ID are generated. In some embodiments, vector stores such as FACEBOOK AI Similarity Search (FAISS) handle the data structure internally.

The following steps describe how the training is performed. First, a large number (e.g., 100,000) of past conversations are considered. With the help of clustering and other heuristics (e.g., removing short concerns, removing concerns where the concern and resolution don't have an overlapping entity), the training selects a smaller set (e.g., 20,000) of conversations in which the concerns are representative of the vast array of problems that have been seen earlier by the customers of that company. Then, that smaller set of actual conversations between customers and agents is sent to (a) a concern model, as well as to (b) a resolution model. In some embodiments, the concern model uses a Generative Pre-Trained Transformer (GPT) (e.g., the Curie model for GPT-3) to generate the concerns given a conversation. In some embodiments, extracting concerns is a relatively simpler problem, which may be adequately handled by the Curie model, which is smaller than other candidate model (e.g., the DaVinci model for GPT-3). With a well-curated prompt, a large number (e.g., 20,000) of concerns corresponding to roughly the same number of conversations are generated. This dataset is used to fine-tune BART, a seq2seq model. In some embodiments, the resolution model generates a brief (e.g., one-or two-line) summary of what the agent did to resolve his or her customer's problem. The approach is again to use a GPT (e.g., the Curie model for GPT-3) with a prompt to generate the resolutions followed by a seq2seq model training (e.g., Longformer). Thus, the system now has collated concerns and resolutions for the smaller set (e.g., 20,000) of conversations.

The next step is to obtain the detailed step-by-step approach the agent took to solve the problem. A GPT (e.g., the DaVinci model for GPT-3) receives the extracted concerns, the resolutions, and the agent's utterances in the corresponding conversations, and then summarizes step-by-step the actions the agent took to solve the customer concerns. In some embodiments, generating a step-by-step summarization is a complex reasoning-based task on which the Curie model may not perform well, in which case other candidate models, such as the DaVinci model, are more appropriate. The combination of the concern, the resolution, and the conversation is provided so that the resolution steps generated by the GPT are aligned with the concern.

Finally, a two-step retrieve-rerank process shows the most appropriate resolution steps that would help solve the agent's query. Both steps use a bi-encoder model, which generates a text embedding for a paragraph or sentence. For the first step, the embedding cosine-similarity between the embedding of all the resolution steps and the embedding of the agent query is employed to retrieve the best (e.g., top 10) results based on the highest cosine-similarity. In the second step, the cosine-similarity between the embeddings of the concerns of the retrieved results and the embedding of the agent query is used to rerank the results based on the new similarity scores. The best (e.g., top 5) results judged as being greater than a certain similarity threshold are finally shown to the agent.

In addition to showing solutions from similar past conversations to the agent, it can also be helpful to show official company internal documentation articles or FAQs to the agent. To prepare a knowledge base of this, each summarized article and FAQ answer, and their embeddings, are stored. For any agent query, the system may then retrieve the best (e.g., top 5) closest articles or questions by again using a cosine similarity-based approach as described above.

The system may be remarkably flexible and incorporate new information and data into the knowledge base over time. By continuing to access actual customer-agent conversations, which describe problems and solutions in detail, the system is able to provide ongoing insight to new agents. These conversations are flowing in real time. One of the benefits of AgentGPT is the extraction of a representative set of conversations that capture a diverse range of customer issues, solved via a clustering-based selection scheme. Instead of creating a searchable index out of mined resolutions, AgentGPT explicitly mines for a summary of concerns expressed by a customer in a conversation, and uses that as a key in the index. An agent's queries to the index are matched against those customer concerns and the index returns the resolutions corresponding to those concerns.

The AgentGPT system thus provides an advanced customer service tool that uses machine learning to analyze past customer-agent conversations and build a knowledge base of problem-resolution steps. The system uses a seq2seq (Sequence-to-Sequence) NLP model to extract customer concerns and corresponding resolutions from the conversations. The extracted data is then used to train a Generative Pre-Trained Transformer (GPT) model to generate concerns and resolutions for a smaller set of conversations. The system also uses a GPT model to summarize the step-by-step approach the agent took to solve the problem. The combination of the concern, the resolution, and the conversation is provided so that the resolution steps generated by the GPT are aligned with the concern. A two-step retrieve-rerank process is used to show the agent the appropriate resolution steps based on the agent's query. The system also includes a head-topic and sub-topic detection module that helps identify trends in customer concerns. This module uses an unsupervised method to generate topics and sub-topics from the mined concerns. The system uses a question-answering model to extract potential entities from each utterance in a conversation. These entities are then clustered to identify head topics. A zero-shot-NLI (natural language inference) classifier is used to detect the entity that represents the main entity in the concern. The sub-topic assignment of any concern is performed through a semantic cosine similarity of the concern and the centroid embedding of the sub-topics. The system is designed to be flexible and can incorporate new information and data into the knowledge base over time. It can also show official company internal documentation articles or FAQs to the agent. The system uses a cosine similarity-based approach to retrieve the closest articles or questions for any agent query.

In some embodiments, the concern model is the concern mining model. This generates a concern from a conversation set (e.g., a set or transcribed text conversations). A concern is a short text summary of a client concern. In some embodiments, the resolution model generates a resolution from the same conversation set. A resolution is a brief description (e.g., 1-2 liner) of what the agent did to resolve the problem. The term “resolution steps” implies the ordered set of steps. In some embodiments, the concern model and resolution model are two separate encoder-decoder models. In some embodiments, the concern (e.g., a 1-2 liner), the resolution (e.g., a 1-2 liner), and the conversation are given to a mode (e.g., a DaVinci model) to generate the “resolution steps” that are the ordered set of steps. In some embodiments, a “prompt” is an issue that the agent wishes to know how to solve (e.g., the customer they are presently talking to is facing the same or similar issue). It may be something such as: “How to block a card that was stolen?” In some embodiments, the “two-stage bi-encoder based retrieve +rerank” model is an abstraction, which may be implemented by an embedding model that can input text and generate embeddings. Thus, on the knowledge base side, embeddings of concerns and the embeddings of resolution steps are stored. When the agent enters a query or prompt, the embedding model also embeds the query. Then a retrieve-rerank operation is performed where the top-10 resolution steps (using cosine similarity over query and resolution steps' embeddings) are first retrieved and then a re-rank operation with the query is performed and the corresponding concerns from the extracted top-10 resolution steps (again using cosine similarity over query and concern embeddings) are generated. This is similar to the operations performed by a bi-encoder.

In some implementations, the AgentGPT system may be designed to learn in real-time from ongoing customer-agent conversations. This real-time learning capability allows the system to continuously update its knowledge base with new concerns and resolutions, thereby improving its ability to provide accurate and relevant recommendations to agents. The system may use machine learning algorithms to identify patterns and trends in the new data, and incorporate these insights into its existing knowledge base.

In some implementations, the AgentGPT system may be equipped with multilingual support to cater to a global user base. The system may be trained on conversations in multiple languages, allowing it to understand and respond to queries in those languages. This feature can be particularly useful for companies that operate in multiple countries and serve customers who speak different languages.

In some implementations, the AgentGPT system may include a sentiment analysis module. This module can analyze the tone and sentiment of the customer's utterances, helping the system to understand the customer's emotional state and adjust its recommendations accordingly. For example, if the customer is frustrated, the system may suggest steps that can quickly resolve the issue and alleviate the customer's frustration.

In some implementations, the AgentGPT system may provide personalized recommendations based on the customer's past interactions and preferences. The system may use machine learning algorithms to analyze the customer's past interactions and identify their preferences. Based on this analysis, the system can tailor its recommendations to the specific customer, thereby improving the effectiveness of the recommendations and enhancing the customer's experience.

In some implementations, the AgentGPT system may include a voice recognition module. This module can convert spoken language into written text, allowing the system to understand and respond to voice queries. This feature can be particularly useful for agents who prefer to interact with the system using voice commands.

In some implementations, the AgentGPT system may incorporate a real-time feedback mechanism. This mechanism allows agents to provide feedback on the recommendations provided by the system. The feedback can be used to continuously improve the system's performance, making it more accurate and relevant over time. For example, if an agent finds a particular recommendation helpful, they can mark it as such. Conversely, if a recommendation is not useful, the agent can indicate this as well. This feedback is then used to adjust the weights in the neural network, potentially improving future recommendations.

The system may also implement a dynamic knowledge base that evolves based on new customer interactions. As new conversations are processed, the system can identify novel concerns or resolution steps that were not previously in its knowledge base. These new elements can be automatically added to the knowledge base, ensuring that the system stays up-to-date with the latest customer issues and resolution strategies. This feature may be particularly useful in industries where products or services frequently change, or where new issues may arise due to external factors.

In some aspects, the AgentGPT system may include a multi-modal input capability. While the primary input may be text-based conversations, the system could be designed to handle other forms of input such as audio recordings of customer calls or even video interactions. For audio inputs, the system may incorporate a speech-to-text module to convert spoken conversations into text that can be processed by the main system. This multi-modal capability may allow the system to be used across various customer service channels, providing a consistent experience regardless of how the customer chooses to interact.

The system may also incorporate an explanation generation module. This module could provide agents with not just recommended steps, but also explanations for why these steps are recommended. By leveraging the attention mechanisms in the transformer architecture, the system could highlight which parts of the input query or historical data were most influential in generating the recommendation. This feature may help agents understand the reasoning behind the system's suggestions, potentially increasing their trust in the system and improving their ability to explain solutions to customers.

In some implementations, the AgentGPT system may include a proactive suggestion feature. Instead of waiting for an agent to input a query, the system could analyze the ongoing conversation in real-time and proactively offer suggestions when it detects potential issues or opportunities. For example, if a customer mentions a specific product, the system could automatically provide the agent with relevant information about that product or common issues associated with it. This feature may help agents stay one step ahead in the conversation, potentially improving customer satisfaction and reducing call times.

The system may also incorporate a customization module that allows individual organizations to tailor the system to their specific needs. This could include the ability to add company-specific terminology to the system's vocabulary, adjust the weighting of different factors in the recommendation algorithm, or even integrate with other internal systems to provide more comprehensive recommendations. This customization capability may ensure that the AgentGPT system can be effectively deployed across a wide range of industries and organizations, each with their unique requirements and workflows.

In some aspects, the AgentGPT system may include a scenario simulation feature. This feature could generate hypothetical customer scenarios based on historical data, allowing agents to practice handling various situations. The system could provide feedback on the agent's responses, helping them improve their skills and familiarize themselves with the system's capabilities. This training mode may be particularly useful for onboarding new agents or helping experienced agents adapt to new products or policies.

The system may also implement a collaborative filtering approach to enhance its recommendations. By analyzing patterns in how different agents handle similar issues, the system could learn to provide personalized recommendations based on an individual agent's style and strengths. For example, if a particular agent has a high success rate with a certain type of customer issue, the system could prioritize recommendations that align with that agent's approach when they encounter similar issues in the future.

In some implementations, the AgentGPT system may incorporate a privacy-preserving feature that ensures sensitive customer information is protected. This could involve techniques such as data anonymization or federated learning, where the model is trained on decentralized data without directly accessing it. This feature may be particularly important in industries dealing with sensitive personal or financial information, ensuring that the system can provide valuable insights while maintaining strict data privacy standards.

### Concern Theme Flow

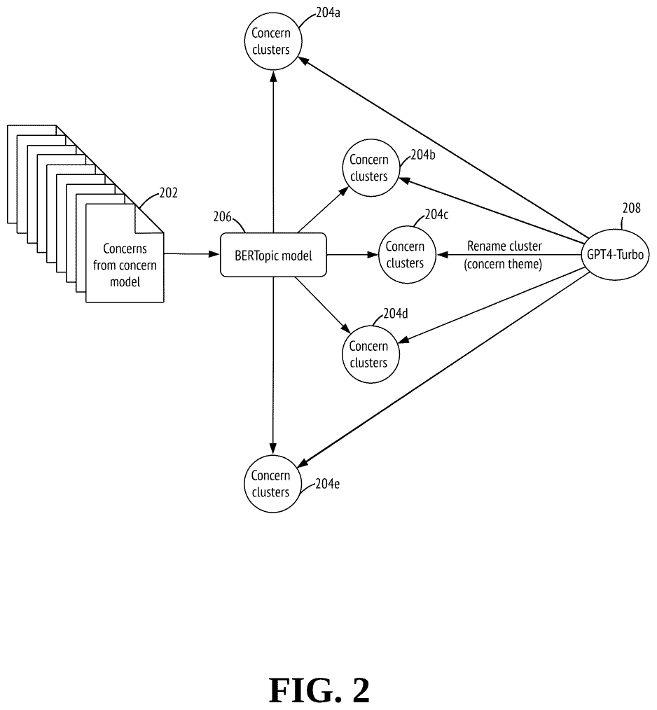

FIG. 2 shows an example concern theme flow, in accordance with the examples disclosed herein. Specifically, the flow diagram illustrates a process flow for analyzing and categorizing concerns using machine learning models. On the left is a stack of concerns 202 from a concern model. These concerns feed into a BERTopic model 206. The BERTopic model 206 then generates multiple concern clusters 204a, 204b, 204c, 204d, and 204e, represented by circular nodes branching out from it. One of these cluster nodes 204c has an additional step, “rename cluster (concern theme),” which connects to a node 208 labeled “GPT4-Turbo.” The GPT4-Turbo node 208 receives input from all the concern cluster nodes 204. This diagram shows a pipeline where initial concerns are processed through a BERTopic model 206 to create clusters 204a, 204b, 204c, 204d, and 204e, which are then potentially renamed or further analyzed using a GPT-4 Turbo model 208. The overall structure shows an approach to categorizing and understanding concerns using multiple machine learning techniques in sequence.

Concern themes are designed to provide additional information about the types of issues and/or concerns under a particular sub-topic. They may be several words (e.g., 15 to 20) long, and the top several (e.g., 10 or 15) themes under each subtopic. Unlike head-topics and subtopics, which are fixed once mined from a large corpus, concern themes are dynamic in the sense that they are computed over a time frame (e.g., a week, a month, a quarter) for each subtopic. Themes created for one week are not the same as the themes created for some other weekly, monthly, or quarterly time frame.

For a given time period and a given subtopic, the concern theme pipeline first aggregates all the themes within that time period. After that, a topic model is trained over those concerns. In some embodiments, BERTopic is the topic model, which includes the following components:
An embedding model, e.g., a bi-encoder: “sentence-transformers/all-mpnet-base-v2”
A clustering model, e.g., KMeans from CUML (GPU-support)
A vectorizer model for topic representations, e.g., CountVectorizer
A representation model to improve topic representation: MaximalMarginalRelevance(diversity=0.4)
A model to reduce embedding dimensionality, e.g., UMAP(n_neighbors=15, n_components=64, min_dist=0.0, metric=‘cosine’, low_memory=false)

Here, the aim may be to create a fixed count of clusters inside the “concerns” corresponding to the given sub-topic/time period combination. One advantage for fixing the number of clusters is because the concerns within a sub-topic may contain great detail, and thus letting some similarity-based metric determine the number of clusters may not lead to meaningful clustering.

Once the topics (a “topic” corresponds to one cluster for a given sub-topic and time period) are identified from the BERTopic model, each such cluster is assigned a meaningful name (a “theme”). Although BERTopic may also assign a name to the topics, such names are usually merely combinations of frequent words in the cluster documents (concerns in this case), whereas a user may prefer the theme to be a properly phrased English sentence. To assign a more meaningful theme phrasing, a set (e.g., of 20) “representative documents” under each cluster is selected, where the representative documents are defined as the closest documents to the cluster centroid. The representative documents are sent to GPT4-Turbo, along with the head topic and subtopic names, which are then assigned a meaningful one-line key theme in fewer than a certain number (e.g., 20) of words.

Once concern themes for a particular subtopic are created, one problem remains. Oftentimes, the themes generated for the clusters may have substantially identical meanings, but are merely worded differently. This is because the number of “themes” inside a subtopic may be less than the number of clusters that the topic model was instructed to find. In such cases, two or more clusters may have documents within them, which are quite similar. To resolve this, for each subtopic, a layer of agglomerative clustering (“AgglomerativeClustering”) is performed on the concern theme names in that subtopic. After this round of clustering, all theme names with similar meanings will be clubbed together. Finally, a single theme name is assigned to each such “cluster of themes,” where a random theme name from the theme names inside a cluster is chosen. This completes the concern theme generation process for a subtopic.

### Head Topic & Sub-topic Detection Pipeline

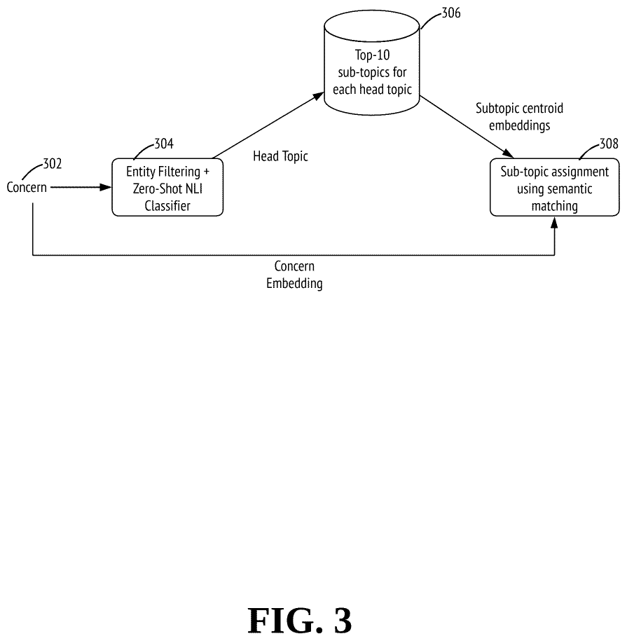

FIG. 3 shows an example head-topic and sub-topic detection pipeline diagram, in accordance with the examples disclosed herein.

A concern 302 is sent to an entity filtering and zero-shot-NLI (natural language inference) classifier 304, which generates a head topic. An entity 306 generates the top few (e.g., 10) sub-topics for each head topic, and generates centroid embeddings for those sub-topics. Sub-topic assignment 308 using semantic matching is performed on the centroid embeddings for those sub-topics and the concern 302.

A head topic and sub-topic detection module helps customers see trends of concerns in the various products and services they offer. The topic and sub-topic detection is completely unsupervised (although it can also accept a list of topics that clients provide), and the system may generate all the topics (entities) and sub-topics from scratch. The head topic and sub-topic detection module sits on top of the concern mining module. After the concerns for a conversation are obtained, the head topic and sub-topic classification are performed. In some embodiments, the topic/sub-topic pipeline is a separate piece and is not related to the AgentGPT system. Topic and sub-topic classification are performed over the concerns, which is the same concern model that AgentGPT uses, but apart from that, they are generally different. The methodology for this is as follows:

### Head Topic (Entity)

The only input to the head topic detection system is a question, which is tailored according to the customer. In some embodiments, this question is defined once manually for a client, based on the line of business they are in. In some embodiments, the single question is fed manually for a particular client. The same question is applied to each utterance of the conversation transcript. In order to extract more entities later on or after the system learns that the company also works in another industry as well, this question may be amended. But the goal is the same: Use this question to obtain answers, which are potential entities. A simple example of a question for a customer working in the finance industry may be: “What is the transaction- or account-related entity that we are talking about?” This question is asked for each utterance in a conversation using a question-answering model (e.g., the roberta-large model fined-tuned using the SQuAD2.0 dataset), and the resulting answers (e.g., spans of text obtained by the model and setting a threshold on the model confidence scores) are candidate entities. Most Q&A models, such as the ones disclosed herein, perform a span extraction, which extracts a substring from the text. This answers the question it was asked, along with a score on the confidence of their answer. In this case, because the question is asked to each utterance, spans from each utterance is received. In some embodiments, if the model is unable to find an answer, it returns an empty string. In some embodiments, an utterance is a single turn of the words, sentences, or series of sentences spoken by a user, such as an agent and a customer in each turn of the conversation. An utterance may even be a single word like “sure.” For example:
customer: <utterance 1>
agent: <utterance 2>
Customer: <utterance 3>
. . .

These are then passed through a hierarchical clustering algorithm (e.g., AffinityPropagation) that uses the word level edit distance between the spans as a distance metric. In some embodiments, the AffinityPropagation hierarchical clustering algorithm is performed over a matrix, which uses the Levenshtein distance for all words (pair-wise). Hence, the number of clusters is not specified (and hence is not required to be fixed), and only the distance threshold to merge clusters may be specified. In some embodiments, this clustering is performed after the answer spans from all the utterances of the conversation we passed the Q&A model through have been received. This clustering is performed once over the entire set of collected answer spans from the conversations to collect all the similar entities. Entities are usually one-word or two-word combinations that are the spans obtained from the Q&A model. The question is framed in a way that long spans are not generated, and even if long spans are generated, they are either low-confidence and hence get filtered before clustering or they do not form the head topic because long spans cannot be the most frequent n-gram in a cluster. It is mostly the former case. The entities as understood from the question may be one or two words describing a particular entity for that business (e.g., account, payment, credit card). Taking a sufficiently high threshold of confidence over the answer spans and the way the original question is formed nearly always ensures that the entities are one or two words only, and also of importance and very rarely are “stop words” (e.g., an, the, and). The most frequent character n-gram of each cluster is assigned the representative topic (head topic) topic of that cluster. In some embodiments, the Affinity Propagation method does not require a cluster count to be provided; it generates the optimal set of clusters. This also helps the user find a large number of head topics because many variations (as separate clusters) may be captured. Next, with some manual curation and cleaning on the head topics and their instances (cluster elements) after the entire clustering has been performed, a list of the head topics, along with their instances (i.e., various word-level modifications that may happen due to ASR transcription errors or word morphological differences) is generated.

Once a list of head entities is obtained, the classification of the head entity for a given concern is performed as follows:
a. Go through all the instances (head entity and its instances) in the curated list and check which of them are present in the concern. In some embodiments, the instances already cover large variations of the head topic, which also includes ASR transcription errors and hence an exact match is performed over the instances. Because the Q&A model ensures that many variants and morphological variants of each head topic are considered, an exact match may be performed. For any of those entities present in the concern, the head entity of that instance is taken to generate a candidate list of the entities which the concern may be talking about.
b. Use a zero-shot-NLI (natural language inference) classifier (e.g., “FACEBOOK/BART-large-mnli”) to detect the entity that best represents the main entity in the concern. This is performed by appending a simple sentence “to which entity does this concern relate?” and providing the filtered list of entities from the above step as candidate answers. In some embodiments, little to no fine-tuning of the classifier is needed.

### Sub-Topic

Once the head entities corresponding to each concern are obtained, the subset of concerns under each head entity (from a very large set of conservation/concern/head entity set) is inputted into a semantic clustering algorithm based on embedding cosine similarity of the concerns using a bi-encoder. In some embodiments, the AgglomerativeClustering is performed, and a distance threshold is specified for each cluster. Then for each head-topic, it may be empirically observed that the top 10 sub-topics within it demonstrate a more than 90% coverage of concerns within that head topic. Thus, for future inferences, the average of the embeddings (e.g., centroid) of the concerns in the top 10 sub-topics are kept. The sub-topic assignment of any concern is performed through a semantic cosine similarity of the concern and the centroid embedding of the sub-topics and taking the closest one above a threshold within the head topic to which the concern belongs.

Once the set of clusters of concerns of the same head entity is obtained, for each cluster, a frequency-based approach assigns a name to the set of clusters of concerns. In some embodiments, this may involve using the most common root word, verb, noun, or object, and concatenating them to generate the name for that cluster. A sample name may then be: “trouble_payment_card_reader”.

An improvement over this approach is to use GPT-3 with a prompt to assign a specific cluster of concerns a name and title.

This completes the head topic-subtopic pipeline.

### Concern Model Training & Inference

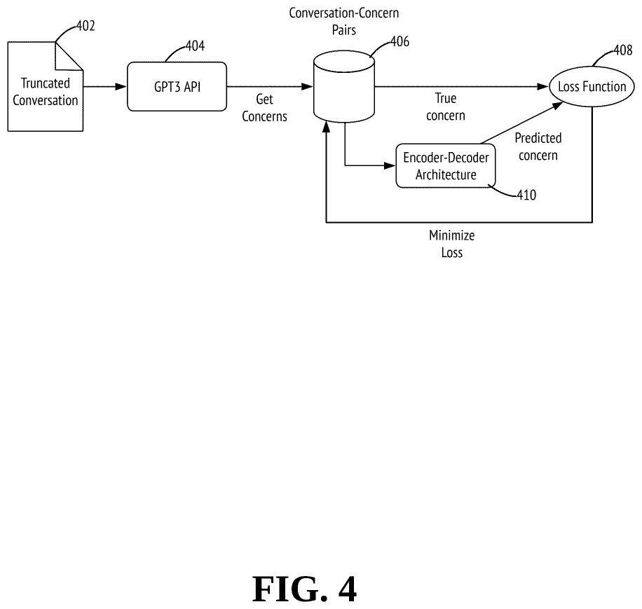

FIG. 4 shows an example concern model training diagram, in accordance with the examples disclosed herein. This describes the process of training data generation for training the concern model. In some embodiments, a conversation is truncated (e.g., to 1,024 tokens) to generate a truncated conversation 402, as customer concerns nearly always appear in the initial part of the conversation. The model is passed through a transformer API 404 (e.g., GPT3/4 API) with a prompt asking it to generate the concern. Once the conversation and corresponding concern pairs 406 are generated, these form the training dataset for training the encoder-decoder architecture 410 (e.g., BART). The same truncated conversation is the input, and the output label is the concern (from the API). Training is performed by minimizing the cross-entropy loss function 408.

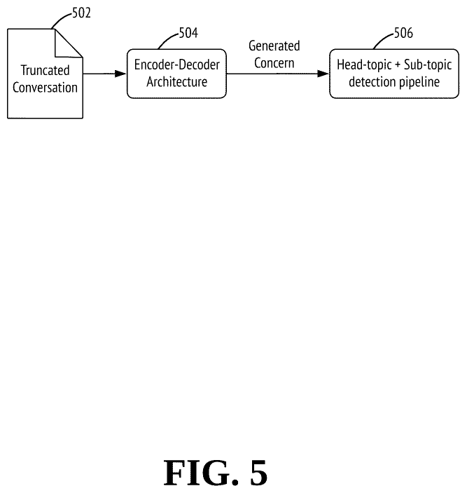

FIG. 5 shows an example concern model inference diagram, in accordance with the examples disclosed herein. This describes the process of inference from the concern model. For a new incoming conversation, the first portion of a truncated conversation 502 (e.g., 1,024 tokens) is passed through the encoder-decoder architecture 504 (e.g., BART) to generate the concerns. This can then be sent to the head-topic and sub-topic detection pipeline 506.

### Resolution Model Training

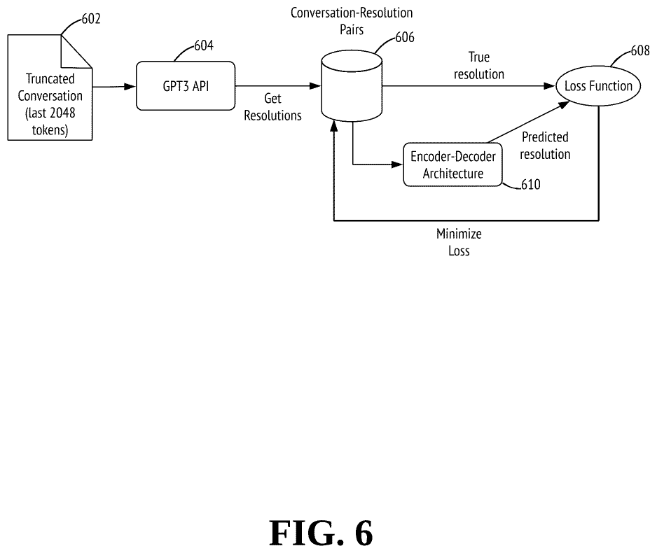

FIG. 6 shows an example resolution model training diagram, in accordance with the examples disclosed herein. This describes the process of training data generation for training the resolution model. In this case, the latter portion of a conversation (e.g., the last 2,048 tokens) is taken as a truncated conversation 602 because resolutions almost always appear in the later part of a conversation. This truncation serves multiple purposes: (a) it focuses the model's attention on the part of the conversation most likely to contain the resolution; (b) it reduces computational requirements by limiting the input size; and (c) it helps maintain consistency in input length, which can improve model performance. The truncated conversation 602 is passed through a transformer API 604 (e.g., GPT3/4 API) with a prompt asking it to generate the resolution. This step leverages the power of large language models to generate high-quality resolution summaries. The API is provided with a carefully crafted prompt that instructs it to extract or generate the resolution from the given conversation snippet. Once the conversation and corresponding resolution pairs 606 are generated, these form the training dataset for training the encoder-decoder architecture 610 (e.g., BART). The same truncated conversation (e.g., the last 2,048 tokens) is the input and the output label is the resolution from the transformer API. During the training phase, the encoder-decoder model learns to map the input (truncated conversation) to the output (resolution summary). This is achieved by minimizing the cross-entropy loss function 608, which measures the difference between the model's predicted resolution and the actual resolution provided by the transformer API. The cross-entropy loss is particularly suitable for this task because: (a) it handles multi-class classification problems well, which is analogous to predicting the next token in a sequence, and (b) it provides a clear signal for the model to improve its predictions, as it heavily penalizes confident misclassifications.

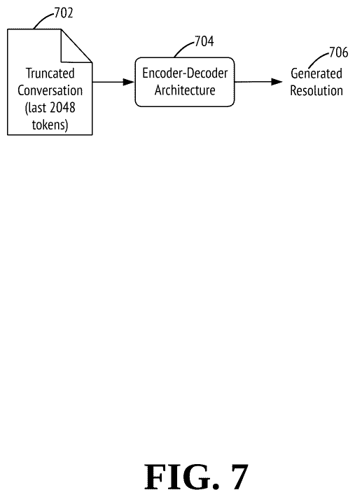

FIG. 7 shows an example resolution model inference diagram, in accordance with the examples disclosed herein. This describes the process of inference from the resolution model. For a new incoming conversation, the latter portion of a conversation (e.g., the last 2,048 tokens) as a truncated conversation 702 is passed through the encoder-decoder architecture 704 (e.g., BART) to generate the resolutions 706. This approach offers several advantages, including:

1. Efficiency: By focusing on the latter part of the conversation, the model can quickly process and respond to ongoing conversations.

2. Relevance: The resolution is typically found in the later part of a conversation, so this approach targets the most relevant information.

3. Adaptability: The model can be fine-tuned on domain-specific data to improve its performance for particular types of customer interactions.

In some implementations, the resolution model may be enhanced with additional features. For example, attention mechanisms may help the model focus on the most important parts of the input when generating the resolution. During inference, a beam search could be used to generate multiple potential resolutions, allowing for more diverse and potentially more accurate outputs. Finally, a copy mechanism may allow the model to directly copy relevant phrases from the input conversation, which may be particularly useful for technical details or specific instructions. The resolution model may also benefit from periodic retraining or fine-tuning as new conversation data becomes available. This ensures that the model stays up-to-date with evolving customer issues and resolution strategies.

In some cases, the resolution model might be integrated with other components of the AgentGPT system. For example, the generated resolutions could be used to update a knowledge base of common issues and their solutions, or to provide suggestions to agents in real-time as they interact with customers.

### Encoder-decoder, Bi-Encoder, and Cross-Encoder Architectures

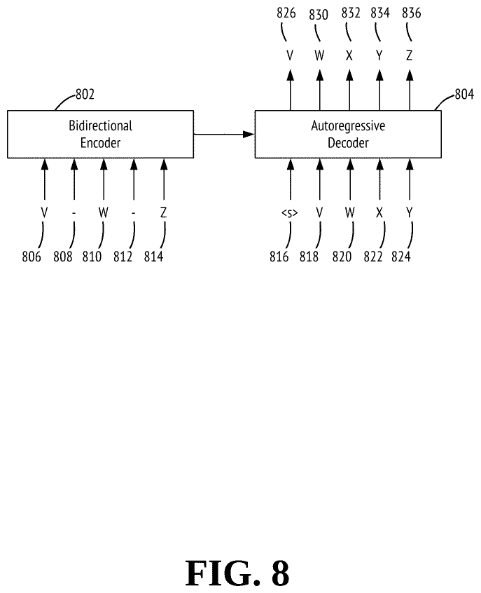

FIG. 8 shows an example encoder-decoder architecture diagram, in accordance with the examples disclosed herein. This is a high-level diagram of the encoder-decoder architecture used for extracting concerns. This is a sequence-to-sequence model that maps a conversation to the concern expressed in it by the customer. In some embodiments, an instantiation of encoder-decoders (e.g., BART) is used. In some embodiments, the encoder takes a portion of a conversation (e.g., 1,024 tokens) as input, and creates a representation for each token. The diagram notes the encoder 802 is “bidirectional”, which means that the representation of each token 806, 808, 810, 812, 814 takes into account tokens at all other positions. The decoder 804 is “autoregressive,” which means that the representation of each token 816, 818, 820, 822, 824 only takes into account the tokens to the left of it, generating another set of tokens 826, 830, 832, 834, 836.

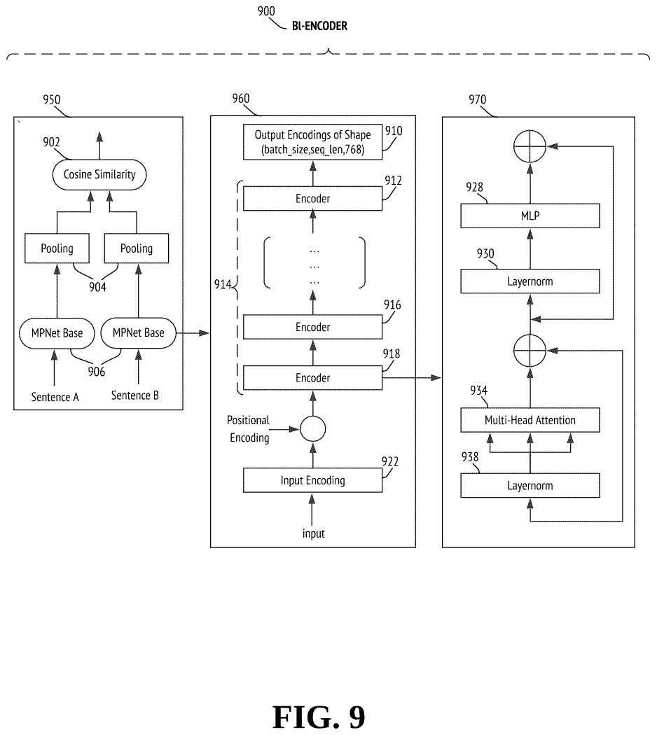

FIG. 9 shows an example block diagram of a bi-encoder 900, in accordance with the examples disclosed herein. Bi-encoders belong to a transformer-based language model class, specifically designed to generate embeddings of sentences. These tools were first introduced in the paper “Sentence-BERT: Sentence Embeddings using Siamese BERT-Networks” by Reimers et. al. (available at arxiv.org/abs/1908.10084), published in August 2019. These tools were introduced as modifications of a pre-trained BERT (Bidirectional Encoder Representations from Transformers) network that uses Siamese and triplet network structures to derive semantically meaningful sentence embeddings that can be compared using cosine similarity 902. A description of BERT can be found in the paper “A Primer in BERTology: What we know about how BERT works” by Rogers et. al. (available at arxiv.org/abs/2002.12327). The purpose of these models is to convert sentences into vectors such that similar sentence vectors are close to one another in the vector space and dissimilar sentence vectors are far away from one another. The models are successfully applied in many tasks, such as large scale semantic similarity comparison, clustering, and information retrieval via semantic search. Although various embodiments using BERT-based models are described herein, other LLM algorithms or other AI-based approaches are within the scope of the present invention.

In some embodiments, the bi-encoder 900 includes a first component 950, a second component 960, and a third component 970. The first component 950 includes one or more MPNet-based models 906, one or more pooling operations 904, and a cosine similarity operation 902, where MPNet stands for “Masked and Permuted Pre-training for Language Understanding” (see Song et. al. April 2020 paper available at arxiv.org/abs/2004.09297). The second component 960 includes input encoding 922, a number (e.g., 9) of encoder stacks 914 (i.e., a stack of encoders in series, which includes encoder 912, encoder 916, and encoder 918), and output encodings of shape 910. The third component 970 includes a layernorm 930, another layernorm 938, multi-head attention 934, and multilayer perceptron (MLP) 928.

The Siamese network architecture enables fixed-sized vectors for input sentences to be derived. Using a similarity measure, such as cosine similarity 902 or Manhattan/Euclidean distance, semantically similar sentences can be found. Bi-encoder class models add a pooling 904 operation to the output of BERT/RoBERTa to derive a fixed-sized sentence embedding, where RoBERTa stands for “RoBERTa: A Robustly Optimized BERT Pretraining Approach” (see Liu et. al., July 2019, and available at arxiv.org/abs/1907.11692).

The triplet objective function tunes a network such that the distance between an anchor sentence α and a positive sentence p is smaller than the distance between a and a negative sentence n. The loss function for this triplet objective function is described above with reference to FIG. 4. Of the bi-encoder models available in Sentence-BERT and the HUGGING FACE collaboration platform, the all-mpnet-base-v2 model 906 (see huggingface.co/sentence-transformers/all-mpnet-base-v2) has been applied to implement the embodiment described in the present disclosure. This model was developed using the pre-trained MICROSOFT/mpnet-base model 906 (see huggingface.co/microsoft/mpnet-base) and fine-tuning it on a 1 billion sentence pairs dataset by using the following contrastive learning objective: Given a sentence from the pair, the model predicts which sentence out of a set of randomly sampled other sentences was actually paired with it in the dataset. Formally, the cosine similarity 902 from each possible sentence pair from the batch is calculated and then cross entropy loss is applied by comparing with those of true pairs. Given an input sentence, it maps sentences to a multi-dimensional (e.g., 768-dimensional) dense vector that captures the semantic information of the given sentence.

The cross entropy loss is computed as follows: Given an input sentence, the model computes a similarity score between that input sentence and N other sentences (where N is a positive integer) of which one sentence is semantically similar to the input sentence. The softmax operation is applied on these scores to generate a categorical distribution over the N sentences (i.e., the “soft-maxed” scores now sum to unity, i.e., 1). To teach the model to maximize the softmaxed score of the sentence that was semantically closest to the input, the cross entropy loss is calculated as the negative logarithm of the softmaxed-score of this closest sentence. Minimizing this cross entropy loss is equivalent to maximizing the softmax-score.

Specifically, this model encodes the given query (i.e., any sentence from an agent-user conversation) and the intent phrases (i.e., phrases that describe an intent), and then the cosine similarity 902 between these phrases is used to determine the best candidate intent for the given query.

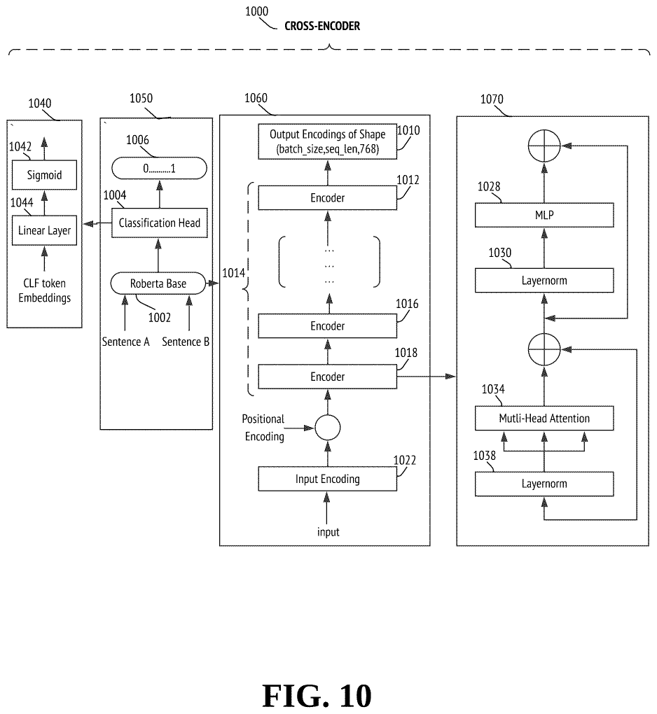

FIG. 10 shows an example block diagram of a cross-encoder 1000, in accordance with the examples disclosed herein. Cross-encoder models also belong to a transformer-based language model class. Unlike bi-encoders, which generate a sentence embedding for a given sentence, cross-encoders generate an output value (e.g., between 0 and 1) indicating the similarity of an input sentence pair. A user or system may provide to a bi-encoder independently sentences A and B, which result in the respective sentence embeddings u and v, while for a cross-encoder, a user or system provides two sentences simultaneously by pairing them. A cross-encoder does not produce a sentence embedding. While a cross-encoder generally produces better results on sentence similarity than a bi-encoder does, it can be computationally expensive, and hence may be impractical for a very large semantic search type operation. Cross-encoders are mostly used whenever the user has a predefined set of sentence pairs to score. For example, a user desires the similarity scores for 100 sentence pairs.

Of the cross-encoder models available in Sentence-BERT and the HUGGING FACE collaboration platform, the stsb-roberta-base model 1002 (see huggingface.co/cross-encoder/stsb-roberta-base) has been applied to implement the present disclosure. This model was developed using the pre-trained Roberta-base model 1002 (see huggingface.co/roberta-base) and fine-tuning it on a sentence similarity dataset, where given a sentence pair, the model's objective outputs a value between 0 and 1, where a value closer to 0 indicates dissimilarity between two sentences and a value closer to 1 indicates similarity between the two sentences. Specifically, the model helps confirm whether the candidate that the bi-encoder tagged as an intent for a given query appropriately belongs to that particular intent class.

In some embodiments, the cross-encoder 1000 includes a first component 1040, a second component 1050, a third component 1060, and a fourth component 1070. The first component 1040 includes a linear layer 1044 that accepts CLS (“Classification”) token embeddings and a sigmoid operator 1042. The second component 1050 includes a Roberta-base model 1002 that accepts sentences (e.g., sentence A, sentence B) and a classification head 1004 that outputs a value 1006 (e.g., between 0 and 1). The third component 1060 includes input encoding 1022, a number (e.g., 9) of encoder stacks 1014 (i.e., a stack of encoders in series, which includes encoder 1012, encoder 1016, and encoder 1018), and output encodings of shape 1010. The fourth component 1070 includes a layernorm 1030, another layernorm 1038, multi-head attention 1034, and multilayer perceptron (MLP) 1028.

The bi-encoder and the cross-encoder coordinate their actions, where the retrieval stage uses the bi-encoder and the rerank stage uses the cross-encoder. In particular, the bi-encoder model is trained on cosine similarity loss and strives to generate high-quality sentence embeddings. In this stage, the system marks the query at hand to a particular intent out of a set of intents. This step may be considered an “intent vs intent classifier,” i.e., its job is to decide to which intent the new query belongs. Next, the rerank stage is the final decider. The model distinguishes between “intent” and “no intent” (“NO_INTENT,” i.e., lack of intent, the utterance is intentless), but in the absence of a model trained for that particular task, a proxy task is performed instead, where the phrases of the given intent are compared with the query at hand. Based on which phrase is the most similar, “intent” or “no intent” (“NO_INTENT,” i.e., lack of intent, the utterance is intentless), is determined.

While the concept of semantic search has been limited to information retrieval and knowledge search, the present disclosure uses embedding based search as a pseudo-task for intent detection. In particular, the system does not match a query with the phrases directly at the bi-encoder stage, but instead matches the query embeddings with intent embeddings, where intent embeddings are found by taking the centroid of all the phrase embeddings for that particular intent. Bi-encoders are generally used to fetch the top few (e.g., 5-10) matching sentences or paragraphs in information retrieval or knowledge search, whereas in the present disclosure, generally only the top choice is returned. In addition, a threshold on the similarity between the query and the centroid of intents, for example, a hyperparameter, may be used. In some embodiments, a validation set on which the threshold is based maximizes the micro-average precision and recall.

Finally, cross-encoders are generally used to rerank and order predictions coming from a bi-encoder in order to generate relevant outputs at the top, whereas the present disclosure uses the cross-encoder similarity output as a “pseudo” in order to determine “intent” versus “no intent” (“NO_INTENT,” i.e., lack of intent, the utterance is intentless) given an intent recommendation from the bi-encoder. A query is classified as an “intent” or as a “no intent” (“NO_INTENT,” i.e., lack of intent, the utterance is intentless) using a threshold on the similarity score from the cross-encoder. This threshold is again a hyperparameter, which may be obtained by optimizing the Micro Average Precision and Recall on a validation set.

### Operation of Transformer-Based Agent Assistant Systems

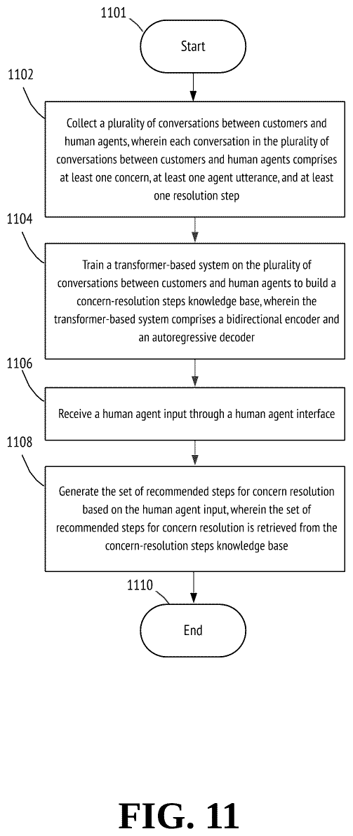

FIG. 11 shows a flow diagram detailing the operation of a transformer-based agent assistant system, in accordance with the examples disclosed herein. In particular, the flow diagram generates a set of recommended steps for concern resolution.

The operation begins in step 1101. In step 1102, the system collects a plurality of conversations between customers and human agents, where each conversation in the plurality of conversations between customers and human agents comprises at least one concern, at least one agent utterance, and at least one resolution step. In step 1104, the system trains a transformer-based system on the plurality of conversations between customers and human agents to build a concern-resolution steps knowledge base, where the transformer-based system comprises a bidirectional encoder and an autoregressive decoder. In step 1106, the system receives a human agent input through a human agent interface. Finally, in step 1108, the system generates the set of recommended steps for concern resolution based on the human agent input, where the set of recommended steps for concern resolution is retrieved from the concern-resolution steps knowledge base. This concludes the operation (step 1110).

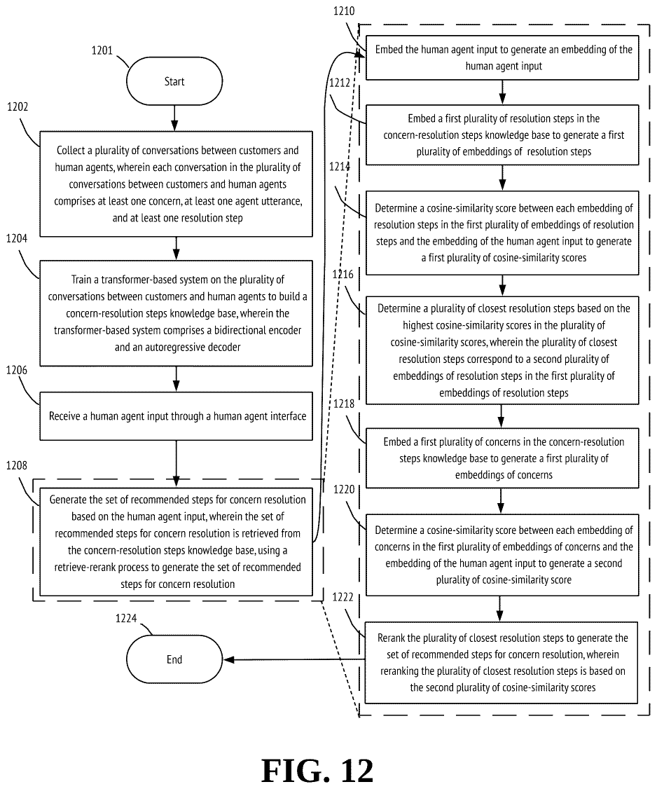

FIG. 12 shows yet another flow diagram detailing the operation of a transformer-based agent assistant system, in accordance with the examples disclosed herein. In particular, the flow diagram generates a set of recommended steps for concern resolution using a retrieve-rerank process.

The operation begins in step 1201. In step 1202, the system collects a plurality of conversations between customers and human agents, where each conversation in the plurality of conversations between customers and human agents comprises at least one concern, at least one agent utterance, and at least one resolution step. In step 1204, the system trains a transformer-based system on the plurality of conversations between customers and human agents to build a concern-resolution steps knowledge base, where the transformer-based system comprises a bidirectional encoder and an autoregressive decoder. In step 1206, the system receives a human agent input through a human agent interface. In step 1208, the system generates the set of recommended steps for concern resolution based on the human agent input, where the set of recommended steps for concern resolution is retrieved from the concern-resolution steps knowledge base.

In order to accomplish step 1208, a retrieve-rerank process is used to generate the set of recommended steps for concern resolution, where the retrieve-rerank process includes the following additional actions. In step 1210, the system embeds the human agent input to generate an embedding of the human agent input. In step 1212, the system embeds a first plurality of resolution steps in the concern-resolution steps knowledge base to generate a first plurality of embeddings of resolution steps. In step 1214, the system determines a cosine-similarity score between each embedding of resolution steps in the first plurality of embeddings of resolution steps and the embedding of the human agent input to generate a first plurality of cosine-similarity scores. In step 1216, the system determines a plurality of closest resolution steps based on the highest cosine-similarity scores in the plurality of cosine-similarity scores, where the plurality of closest resolution steps correspond to a second plurality of embeddings of resolution steps in the first plurality of embeddings of resolution steps. In step 1218, the system embeds a first plurality of concerns in the concern-resolution steps knowledge base to generate a first plurality of embeddings of concerns. In step 1220, the system determines a cosine-similarity score between each embedding of concerns in the first plurality of embeddings of concerns and the embedding of the human agent input to generate a second plurality of cosine-similarity scores. Finally, in step 1222, the system reranks the plurality of closest resolution steps to generate the set of recommended steps for concern resolution, where reranking the plurality of closest resolution steps is based on the second plurality of cosine-similarity scores. This concludes the operation (step 1224).

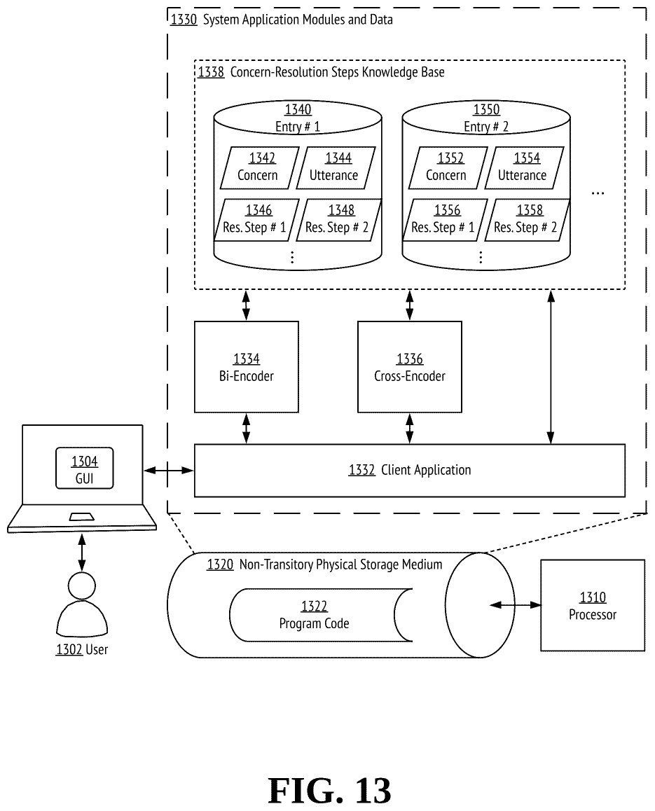

FIG. 13 shows a system diagram illustrating a transformer-based agent assistant system, in accordance with the examples disclosed herein. The system includes access to at least one hardware processor 1310 responsible for executing program code 1322 to implement the modules 1330 described below. The system includes access to at least one non-transitory physical storage medium 1320, accessible by the at least one hardware processor 1310, which stores the program code 1322 that is executable by the hardware processor 1310. The program code may be stored and distributed among two or more non-transitory physical storage media, and may be executed by two or more processors. The system may further include a Graphical User Interface (GUI) 1304 allowing a user 1302 (e.g., a client or an agent) to interact with the system modules 1330.

In various embodiments, the transformer-based agent assistant system may incorporate the modules and databases described in the present disclosure, including:
a client application 1332 for coordinating the transformer-based agent assistant system and for running the various methods described herein,
a bi-encoder ML model 1334 trained to generate embedding or context vectors from sentences, as further detailed in the present disclosure,
a cross-encoder ML model 1336 trained to compare embedding and/or context vectors, as further detailed in the present disclosure,
a concern-resolution steps knowledge base 1338, including data associated with one or more entries (e.g., 1340, 1350). For any given entry, the scenario data 1338 may include an extracted concern, an extracted utterance, and an extracted resolution step related to that entry. For example, for entry #1 (1340), FIG. 13 shows concern 1342, utterance 1344, and resolution steps 1346, 1348, etc., and for entry #2 (1350), FIG. 13 shows concern 1352, utterance 1354, and resolution steps 1356, 1358, etc.

### Machine Learning (ml) and Neural Networks

Machine learning (ML) algorithms are characterized by the ability to improve their performance at a task over time without being explicitly programmed with the rules to perform that task (i.e., learn). A machine learning (ML) model is the output generated when a ML algorithm is trained on data. As described herein, embodiments of the present invention use one or more artificial intelligence (AI) and machine learning (ML) algorithms for transformer-based agent assistant systems. Various exemplary ML algorithms are within the scope of the present invention. The following description describes illustrative ML techniques for implementing various embodiments of the present invention.

### Neural Networks

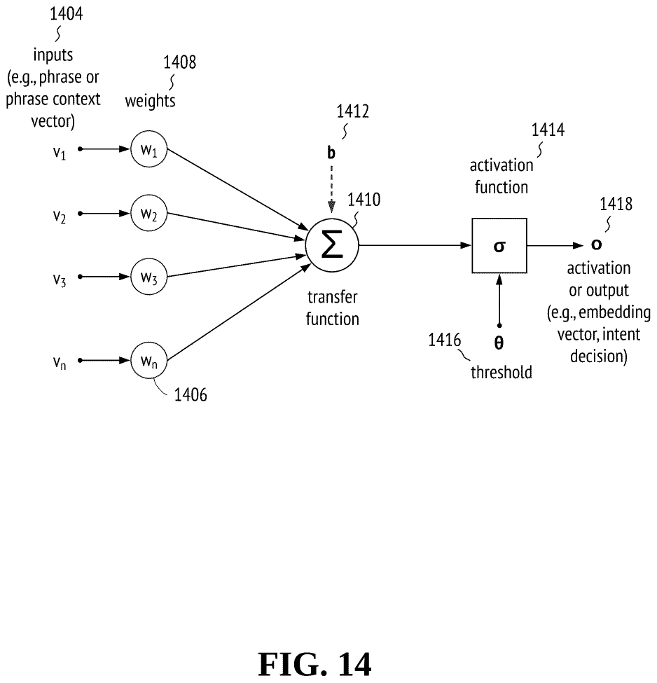

A neural network is a computational model inspired by the structure of the human brain, consisting of interconnected units called neurons that work together to process information. It is a type of ML algorithm that is particularly effective for recognizing patterns and making predictions based on complex data. Neural networks are widely used in various applications such as image and speech recognition and natural language processing, due to their ability to learn from large amounts of data and improve their performance over time. FIG. 14 describes fundamental neural network operation as it relates to a transformer-based agent assistant system, according to exemplary embodiments of the present invention.

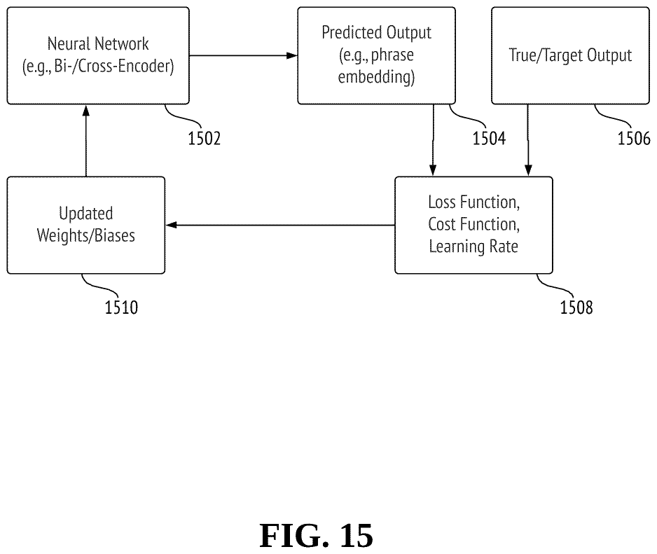

FIG. 14 shows a single-layered neural network, also known as a single-layer perceptron. Such a perceptron is the building block for neural networking layers included in bi-encoder and cross-encoders, according to embodiments of the present invention. The operation of a single-layered neural network involves the following steps:
1. Input: Receiving an input vector v 1404 with elements vⱼ, with j∈[1,n] representing the j^{th} input, and where each element of the vector corresponds to a neuron 1406 in the input layer. In a transformer-based agent assistant system, the input vector may be the letters, syllables, or words of a phrase, utterance, or sentence. The input vector may also be the elements of a phrase context vector or embedding vector, as described in the present disclosure.
2. Transfer Function: Multiplying each input by a corresponding weight wⱼ 1408. These weighted inputs are then summed together as the transfer function, yielding the net input to the activation function Σⱼ₌₁ⁿ vⱼ·wⱼ 1410.
Each neuron in a neural network may have a bias value 1412, which is added to the weighted sum of the inputs to that neuron. Both the weights and bias values are learned during the training process. The purpose of the bias is to provide every neuron with a trainable constant value that can help the model fit the data better. With biases, the net input to the activation function is Σⱼ₌1ⁿ {vⱼ·wⱼ}+b.
3. Activation Function: Passing the net input through an activation function 1414. The activation function σ determines the activation value ο 1418, which is the output of the neuron. It is typically a non-linear function such as a sigmoid or ReLU (Rectified Linear Unit) function. The threshold θ 1416 of the activation function is a value that determines whether a neuron is activated or not. In some activation functions, such as the step function, the threshold is a specific value. If the net input is above the threshold, the neuron outputs a constant value, and if it's below the threshold, it outputs a zero value. In other activation functions, such as the sigmoid or ReLU (Rectified Linear Unit) functions, the threshold is not a specific value but rather a point of transition in the function's curve.
4. Output: The activation value ο 1418 is the output of the activation function. This value is what gets passed on to the next layer in the network or becomes the final output in the case of the last layer.
FIG. 15 shows an overview of the neural network training process that can be used in a transformer-based agent assistant system, according to exemplary embodiments of the present invention.

In a transformer-based agent assistant system, the neural network 1502 undergoing the training may be a bi-encoder or a cross-encoder, as described in the present disclosure. The training of a neural network involves repeatedly updating the weights and biases 1510 of the network to minimize the difference between the predicted output 1504 and the true or target output 1506, where the predicted output is the result produced by the network when a set of inputs from a dataset is passed through it. The true or target output 1506 is the true desired result. The difference between the predicted output and the true output is calculated using a loss function 1508, which quantifies the error made by the network in its predictions.

The loss function is a part of the cost function 1508, which is a measure of how well the network is performing over the whole dataset. The goal of training is to minimize the cost function 1508. This is achieved by iteratively adjusting the weights and biases 1510 of the network in the direction that leads to the steepest descent in the cost function. The size of these adjustments is determined by the learning rate 1508, a hyperparameter that controls how much the weights and biases change in each iteration. A smaller learning rate means smaller changes and a slower convergence towards the minimum of the cost function, while a larger learning rate means larger changes and a faster convergence, but with the risk of overshooting the minimum.

Neural network training combines the processes of forward propagation and backpropagation. Forward propagation is the process where the input data is passed through the network from the input layer to the output layer. During forward propagation, the weights and biases of the network are used to calculate the output for a given input. Backpropagation, on the other hand, is the process used to update the weights and biases 1510 of the network based on the error (e.g., cost function) 1508 of the output. After forward propagation through neural network 1502, the output 1504 of the network is compared with true output 1506, and the error 1508 is calculated. This error is then propagated back through the network, starting from the output layer and moving towards the input layer. The weights and biases 1510 are adjusted in a way that minimizes this error. This process is repeated for multiple iterations or epochs until the network is able to make accurate predictions.

The neural network training method described above, in which the network is trained on a labeled dataset (e.g., sample pairs of input user prompts and corresponding output recommendations), where the true outputs are known, is called supervised learning. In unsupervised learning, the network is trained on an unlabeled dataset, and the goal is to discover hidden patterns or structures in the data. The network is not provided with the true outputs, and the training is based on the intrinsic properties of the data. Furthermore, reinforcement learning is a type of learning where an agent learns to make decisions from the rewards or punishments it receives based on its actions. Although reinforcement learning does not typically rely on a pre-existing dataset, some forms of reinforcement learning can use a database of past actions, states, and rewards during the learning process. Any neural network training method that uses a labeled dataset is within the scope of the methods and systems described herein, as is clear from the overview below.

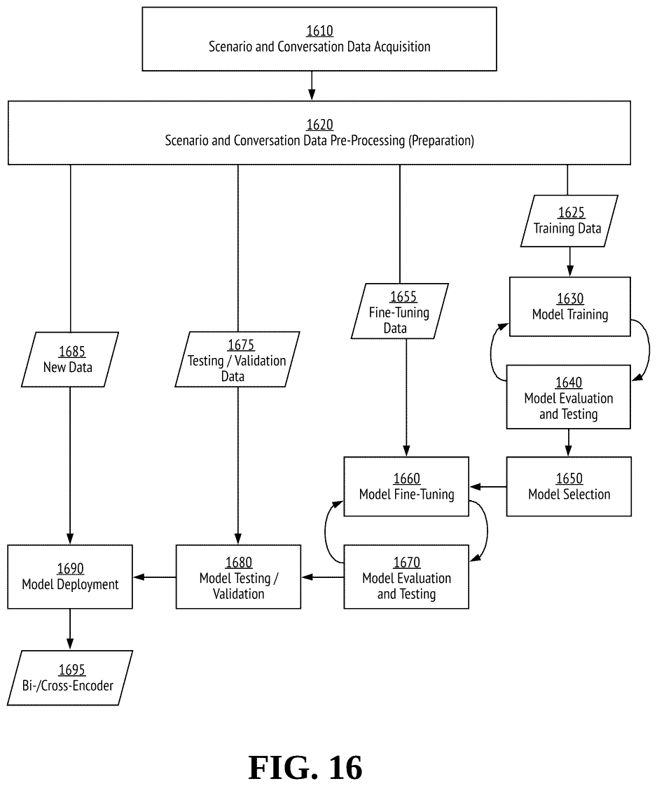

FIG. 16 provides additional details on the training process, according to exemplary embodiments of the present invention.

### Transformer Model Architecture

The transformer architecture, as used by the bi-encoder and cross-encoder described in FIGS. 4-7, is a neural network design that was introduced in the paper “Attention is All You Need” by Vaswani et al. (available at arxiv.org/abs/1706.03762) published in June 2017, and incorporated herein by reference as if fully set forth herein. Large Language Models (LLMs) heavily rely on the transformer architecture.

The architecture (see FIG. 1 of the referenced paper) is based on the concept of “attention,” allowing the model to focus on different parts of the input sequence when producing an output. Transformers comprises an encoder and a decoder. The encoder processes the input data and the decoder generates the output. Each of these components is made up of multiple layers of self-attention and point-wise, fully connected layers.

The layers of self-attention in the transformer model allow it to weigh the relevance of different parts of the input sequence when generating an output, thereby enabling it to capture long-range dependencies in the data. On the other hand, the fully connected layers are used for transforming the output of the self-attention layers, adding complexity and depth to the model's learning capability.

The transformer model is known for its ability to handle long sequences of data, making it particularly effective for tasks such as machine translation and text summarization. In the transformer architecture, positional encoding is used to give the model information about the relative positions of the words in the input sequence. Since the model itself does not have any inherent sense of order or sequence, positional encoding is a way to inject some order information into the otherwise order-agnostic attention mechanism.

### The Embeddings Vector Space

In the context of neural networks, tokenization refers to the process of converting the input and output spaces, such as natural language text or programming code, into discrete units or “tokens.” This process allows the network to effectively process and understand the data, as it transforms complex structures into manageable, individual elements that the model can learn from and generate.

In the training of neural networks, embeddings serve as a form of distributed word representation that converts discrete categorical variables (i.e., tokens) into a continuous vector space (i.e., embedding vectors). This conversion process captures the semantic properties of tokens, enabling tokens with similar meanings to have similar embeddings. These embeddings provide a dense representation of tokens and their semantic relationships. Embeddings are typically represented as vectors, but may also be represented as matrices or tensors.

The input of a transformer typically requires conversion from an input space (e.g., the natural language token space) to an embeddings space. This process, referred to as “encoding,” transforms discrete inputs (tokens) into continuous vector representations (embeddings). This conversion is a prerequisite for the transformer model to process the input data and understand the semantic relationships between tokens (e.g., words). Similarly, the output of a transformer typically requires conversion from the embeddings space to an output space (e.g., natural language tokens, programming code tokens, etc.), in a process referred to as “decoding.” Therefore, the training of a neural network and its evaluation (i.e., its use upon deployment) both occur within the embeddings space.

In the remainder of this document, the processes of tokenization, encoding, decoding, and detokenization are assumed. In other words, the processes described below occur in the “embeddings space.” Hence, while the tokenization and encoding of training data and input prompts may not be represented or discussed explicitly, they are implied. Similarly, the decoding and detokenization of neural network outputs are also implied.

### Training and Fine-tuning Machine Learning (ml) Modules

FIG. 16 is an illustrative flow diagram showing the different phases and datasets involved in training a machine learning algorithm for a transformer-based agent assistant system, according to exemplary embodiments of the present invention.

The training process begins at step 1610 with the acquisition, retrieval, assimilation, or generation of scenario and conversation data. At step 1620, acquired data are pre-processed, or prepared. At step 1630, the ML model (e.g., bi-encoder or cross-encoder) is trained using training data 1625. At step 1640, the ML model is evaluated, validated, and tested, and further refinements to the ML model are fed back into step 1630 for additional training. Once its performance is acceptable, at step 1650, optimal model parameters are selected.

Training data 1625 is a documented data set containing multiple instances of system inputs and correct outcomes. It trains the ML model to optimize the performance for a specific target task. In FIG. 16, training data 1625 may also include subsets for validating and testing the ML model, as part of the training iterations 1630 and 1640. For an NN-based ML model, the quality of the output may depend on (a) NN architecture design and hyperparameter configurations, (b) NN coefficient or parameter optimization, and (c) quality of the training data set. These components may be refined and optimized using various methods. For example, training data 2825 may be expanded via an augmentation process.

In some embodiments, an additional fine-tuning 1660 phase including iterative fine-tuning 1660 and evaluation, validation, and testing 1670 steps, is carried out using fine-tuning data 1655. Fine-tuning in machine learning is a process that involves taking a selected 1650 pre-trained model and further adjusting or “tuning” its parameters to better suit a specific task or fine-tuning dataset 1655. This technique is particularly useful when dealing with deep learning models that have been trained on large, general training datasets 1625 and are intended to be applied to more specialized tasks or smaller datasets. The objective is to leverage the knowledge the model has already acquired during its initial training (often referred to as transfer learning) and refine it so that the model performs better on a more specific task at hand.

The fine-tuning process typically starts with a model that has already been trained on a large benchmark training dataset 1625, such as ImageNet for image recognition tasks. The model's existing weights, which have been learned from the original training, serve as the starting point. During fine-tuning, the model is trained further on a new fine-tuning dataset 1655, which may contain different classes or types of data than the original training set. This additional training phase allows the model to adjust its weights to better capture the characteristics of the new fine-tuning dataset 1655, thereby improving its performance on the specific task it is being fine-tuned for.

In some embodiments, additional test and validation 1680 phases are performed using test and validation data 1675. Testing and validation of a ML model both refer to the process of evaluating the model's performance on a separate dataset 1675 that was not used during training, to ensure that it generalizes well to new unseen data. Validation of a ML model helps to prevent overfitting by ensuring that the model's performance generalizes beyond the training data.

While the validation phase is considered part of ML model development and may lead to further rounds of fine-tuning, the testing phase is the final evaluation of the model's performance after the model has been trained and validated. The testing phase provides an unbiased assessment of the final model's performance that reflects how well the model is expected to perform on unseen data, and is usually carried out after the model has been finalized to ensure the evaluation is unbiased.

Once the model is trained 1630, selected 1650, and optionally fine-tuned 1660 and validated/tested 1680, it is deployed 1690. Deployed ML models such as the bi-encoder and cross-encoder 1695 usually receive new data 1685 that was pre-processed 1620.

In machine learning, data pre-processing 1620 is tailored to the phase of model development. During model training 1630, pre-processing involves cleaning, normalizing, and transforming raw data into a format suitable for learning patterns. For fine-tuning 1660, pre-processing adapts the data to align with the distribution of the specific targeted task, ensuring the pre-trained model can effectively transfer its knowledge. Validation 1680 pre-processing mirrors that of training to accurately assess model generalization without leakage of information from the training set. Finally, in deployment (1690 and 1695), pre-processing ensures real-world data matches the trained model's expectations, often involving dynamic adjustments to maintain consistency with the training and validation stages.

### Machine Learning Algorithms

Various exemplary ML algorithms are within the scope of the present invention. Such machine learning algorithms include, but are not limited to, random forest, nearest neighbor, decision trees, support vector machines (SVM), Adaboost, gradient boosting, Bayesian networks, evolutionary algorithms, various neural networks (including deep learning networks (DLN), convolutional neural networks (CNN), and recurrent neural networks (RNN)), etc.

ML modules based on transformers and Large Language Models (LLMs) are particularly well suited for the tasks described herein. The online article “Understanding Large Language Models—A Transformative Reading List,” by S. Raschka (posted Feb. 7, 2023, available at sebastianraschka.com/blog/2023/llm-reading-list.html), describes various LLM architectures that are within the scope of the methods and systems described herein, and is hereby incorporated by reference in its entirety herein as if fully set forth herein.

The input to each of the listed ML modules is a feature vector comprising the input data described above for each ML module. The output of the ML module is a feature vector comprising the corresponding output data described above for each ML module.

Prior to deployment, each of the ML modules listed above may be trained on one or more respective sample input datasets and on one or more corresponding sample output datasets. The input and output training datasets may be generated from a database containing a history of input instances and output instances, or may be generated synthetically by subject matter experts.

### Exemplary System Architecture

An exemplary embodiment of the present disclosure may include one or more servers (management computing entities), one or more networks, and one or more clients (user computing entities). Each of these components, entities, devices, and systems (similar terms used herein interchangeably) may be in direct or indirect communication with, for example, one another over the same or different wired or wireless networks.

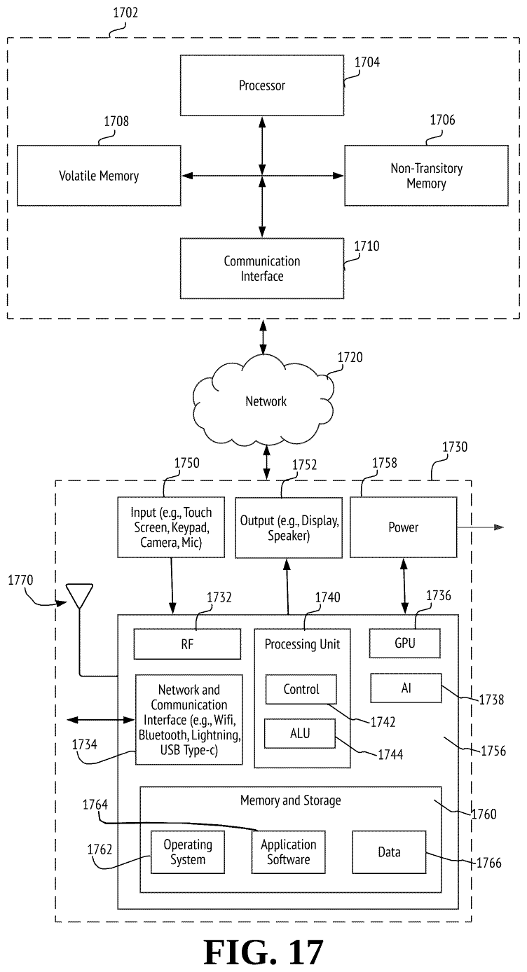

FIG. 17 provides illustrative schematics of a server (management computing entity) 1702 connected via a network 1720 to a client (user computing entity) 1730 used for communication within a transformer-based agent assistant system, according to some embodiments of the present invention. While FIG. 17 illustrates the various system entities as separate, standalone entities, the various embodiments are not limited to this particular architecture. Additionally, the terms “client device,” “client computing entity,” “edge device,” and “edge computing system” are equivalent and are used interchangeably herein.

### Exemplary Management Computing Entity

FIG. 17 provides a schematic of a server (management computing entity, 1702) according to one embodiment of the present disclosure. In general, the terms computing entity, computer, entity, device, system, and/or similar words used herein interchangeably may refer to, for example, one or more computers, computing entities, desktop computers, mobile phones, tablets, phablets, notebooks, laptops, distributed systems, gaming consoles, watches, glasses, iBeacons, proximity beacons, key fobs, radio frequency identification (RFID) tags, earpieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, and/or comparing (similar terms used herein interchangeably). In one embodiment, these functions, operations, and/or processes can be performed on data, content, and/or information (similar terms used herein interchangeably).

As indicated, in one embodiment, the management computing entity (1702) may also include one or more communications interfaces (1710) for communicating with various computing entities, such as by communicating data, content, and/or information (similar terms used herein interchangeably) that can be transmitted, received, operated on, processed, displayed, stored, and/or the like.

As shown in FIG. 17, in one embodiment, the management computing entity (1702) may include or be in communication with one or more processors (i.e., processing elements, 1704, also referred to as processors and/or processing circuitry, and similar terms used herein interchangeably) that communicate with other elements within the management computing entity (1702) via a bus, for example. As will be understood, the processor (1704) may be embodied in a number of different ways. For example, the processor (1704) may be embodied as one or more complex programmable logic devices (CPLDs), microprocessors, multi-core processors, co-processing entities, application-specific instruction-set processors (ASIPs), microcontrollers, and/or controllers. Further, the processor (1704) may be embodied as one or more other processing devices or circuitry. The term circuitry may refer to an entire hardware embodiment or a combination of hardware and computer program products. Thus, the processor (1704) may be embodied as integrated circuits, application-specific integrated circuits (ASICs), field-programmable gate arrays (FPGAs), programmable logic arrays (PLAs), hardware accelerators, other circuitry, and/or the like. As will therefore be understood, the processor (1704) may be configured for a particular use or configured to execute instructions stored in volatile or non-volatile (or non-transitory) media or otherwise accessible to the processor (1704). As such, whether configured by hardware or computer program products, or by a combination thereof, the processor (1704) may be capable of performing steps or operations according to embodiments of the present disclosure when configured accordingly.

In one embodiment, the management computing entity (1702) may further include or be in communication with non-transitory memory (also referred to as non-volatile media, non-volatile storage, non-transitory storage, memory, memory storage, and/or memory circuitry—similar terms used herein interchangeably). In one embodiment, the non-transitory memory or storage may include one or more non-transitory memory or storage media (1706), including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile (or non-transitory) storage or memory media may store databases, database instances, database management systems, data, applications, programs, program modules, scripts, source code, object code, byte code, compiled code, interpreted code, machine code, executable instructions, and/or the like. The term database, database instance, and/or database management system (similar terms used herein interchangeably) may refer to a collection of records or data that is stored in a computer-readable storage medium using one or more database models, such as a hierarchical database model, network model, relational model, entity-relationship model, object model, document model, semantic model, graph model, and/or the like.

In one embodiment, the management computing entity (1702) may further include or be in communication with volatile media (also referred to as volatile storage, memory, memory storage, memory and/or circuitry—similar terms used herein interchangeably). In one embodiment, the volatile storage or memory may also include one or more volatile storage or memory media 1708, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processor (1704). Thus, the databases, database instances, database management systems, data, applications, programs, program modules, scripts, source code, object code, byte code, compiled code, interpreted code, machine code, executable instructions, and/or the like may be used to control certain aspects of the operation of the management computing entity (1702) with the assistance of the processor (1704) and operating system.

As indicated, in one embodiment, the management computing entity (1702) may also include one or more communications interfaces (1710) for communicating with various computing entities, such as by communicating data, content, and/or information (similar terms used herein interchangeably) that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the management computing entity (1702) may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High-Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the management computing entity (1702) may include or be in communication with one or more input elements, such as a keyboard input, a mouse input, a touch screen/display input, motion input, movement input, audio input, pointing device input, joystick input, keypad input, and/or the like. The management computing entity (1702) may also include or be in communication with one or more output elements (not shown), such as audio output, video output, screen/display output, motion output, movement output, and/or the like.

As will be appreciated, one or more of the components of the management computing entity (1702) may be located remotely from other management computing entity (1702) components, such as in a distributed system. Furthermore, one or more of the components may be combined and additional components performing functions described herein may be included in the management computing entity (1702). Thus, the management computing entity (1702) can be adapted to accommodate a variety of needs and circumstances. As will be recognized, these architectures and descriptions are provided for exemplary purposes only and are not limited to the various embodiments.

### Exemplary User Computing Entity

A user may be a human individual, a company, an organization, an entity, a department within an organization, a representative of an organization and/or person, an artificial users such as algorithms, artificial intelligence, or other software that interfaces, and/or the like. FIG. 17 further provides an illustrative schematic representation of a client user computing entity 1730 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles, watches, glasses, key fobs, radio frequency identification (RFID) tags, earpieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. User computing entities can be operated by various parties. Such functions, operations, and/or processes may include, for example, transmitting, receiving, retrieving, operating on, crawling, extracting, processing, displaying, storing, determining, creating, generating, generating for display, monitoring, evaluating, comparing, and/or similar terms used herein interchangeably. In various embodiments, these functions, operations, and/or processes can be performed on machine-readable or human-readable data, content, information, and/or similar terms used herein interchangeably. Furthermore, in embodiments of the present invention, computing device 1730 may be a general-purpose computing device with dedicated graphical processing unit (GPU) 1736 and artificial intelligence 1738 modules. In some embodiments, computing device 1730 may be built over a backplane 1756 connected to a power source 1758. It may alternatively be implemented in the cloud, with logically and/or physically distributed architectures.

As shown in FIG. 17, user computing entity 1730 may include an antenna 1770, a radio frequency (RF) transceiver 1732, and a processor unit 1740 that provides signals to and receives signals from the transceiver. The signals provided to and received from the transceiver may include signaling information in accordance with air interface standards of applicable wireless systems. In this regard, the user computing entity (1730) may be capable of operating with one or more air interface standards, communication protocols, modulation types, and access types. More particularly, user computing entity 1730 may operate in accordance with any of a number of wireless communication standards and protocols, such as those described above with regard to management computing entity 1702. In a particular embodiment, user computing entity 1730 may operate in accordance with multiple wireless communication standards and Protocols, Such AS UMTS, CDMA2000, 1XRTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, user computing entity 1730 may operate in accordance with multiple wired communication standards and protocols, such as those described above with regard to management computing entity 1702, via its own network and communications interface 1734.

Via these communication standards and protocols, user computing entity 1730 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). User computing entity 1730 can also download changes, add-ons, and updates, for instance, to its firmware, software (e.g., including executable instructions, applications, program modules), and operating system.

In some implementations, processing unit 1740 may be embodied in several different ways. For example, processing unit 1740 may be embodied as one or more complex programmable logic devices (CPLDs), microprocessors, multi-core processors, co-processing entities, application-specific instruction-set processors (ASIPs), microcontrollers, and/or controllers. Further, processing unit 1740 may be embodied as one or more other processing devices or circuitry. The term circuitry may refer to an entire hardware embodiment or a combination of hardware and computer program products. Thus, processing unit 1740 may be embodied as integrated circuits, application specific integrated circuits (ASICs), field programmable gate arrays (FPGAs), programmable logic arrays (PLAs), hardware accelerators, other circuitry, and/or the like. As will therefore be understood, processing unit 1740 may be configured for a particular use or configured to execute instructions stored in volatile or non-volatile media or otherwise accessible to the processing unit. As such, whether configured by hardware or computer program products, or by a combination thereof, processing unit 1740 may be capable of performing steps or operations according to embodiments of the present invention when configured accordingly.

In some embodiments, processing unit 1740 may comprise a control unit 1742 and a dedicated arithmetic logic unit (ALU) 1744 to perform arithmetic and logic operations. In some embodiments, user computing entity 1730 may comprise a graphics processing unit (GPU) 1746 for specialized parallel processing tasks, and/or an artificial intelligence (AI) module or accelerator 1748, also specialized for applications including artificial neural networks and machine learning. In some embodiments, processing unit 1740 may be coupled with GPU 1746 and/or AI accelerator 1748 to distribute and coordinate processing tasks.

In some embodiments, computing entity 1730 may include a user interface, comprising an input interface 1750 and an output interface 1752, each coupled to processing unit 1740. User input interface 1750 may comprise any of a number of devices or interfaces allowing computing entity 1730 to receive data, such as a keypad (hard or soft), a touch display, a mic for voice/speech, and a camera for motion or posture interfaces. User output interface 1752 may comprise any of a number of devices or interfaces allowing computing entity 1730 to provide information to a user, such as through the touch display, or a speaker for audio outputs. In some embodiments, output interface 1752 may connect computing entity 1730 to an external loudspeaker or projector, for audio or visual output. In some embodiments, user interfaces 1750 and 1752 integrate multimodal data, and cater to both humans and bots/algorithms. Some examples of human interfaces include a dashboard-style interface, a workflow-based interface, conversational interfaces, and spatial-computer interfaces. Some examples of bot/algorithmic interfaces include code interfaces, text-based API interfaces, and the like.

User computing entity 1730 can also include volatile and/or non-volatile storage or memory 1760, which can be embedded and/or may be removable. For example, the non-volatile or non-transitory memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile (or non-transitory) storage or memory can store an operating system 1762, application software 1764, data 1766, databases, database instances, database management systems, data, applications, programs, program modules, scripts, source code, object code, byte code, compiled code, interpreted code, machine code, executable instructions, and/or the like to implement the functions of the user computing entity (1730). As indicated, this may include a user application that is resident on the entity or accessible through a browser or other user interface for communicating with the management computing entity (1702) and/or various other computing entities.

In some embodiments, user computing entity 1730 may include one or more components or functionalities that are the same or similar to those of management computing entity 1702, as described in greater detail above. As will be recognized, these architectures and descriptions are provided for exemplary purposes only and are not limited to the various embodiments.

In some embodiments, computing entities 1710 and/or 1730 may communicate to external devices like other computing devices and/or access points to receive information such as software or firmware, or to send information from the memory of the computing entity to external systems or devices such as servers, computers, smartphones, and the like.

In some embodiments, two or more computing entities such as 1710 and/or 1730 may establish connections using a network such as 1720 utilizing any of the networking protocols listed previously. In some embodiments, the computing entities may use network interfaces such as 1710 and 1734 to communicate with each other, such as by communicating data, content, information, and/or similar terms used herein interchangeably that can be transmitted, received, operated on, processed, displayed, stored, and/or the like.

In some embodiments of the present invention, the entire system may be implemented and offered to the end-users and operators over the Internet, in a so-called cloud implementation. No local installation of software or hardware would be needed. The end-users and operators would be allowed access to the systems of the present invention directly over the Internet, using either a web browser or similar software on a client, which client could be a desktop, laptop, mobile device, and so on. This eliminates any need for custom software installation on the client side and increases the flexibility of delivery of the service (software-as-a-service) and increases user satisfaction and ease of use. Various business models, revenue models, and delivery mechanisms for the present invention are envisioned, and are all to be considered within the scope of the present invention.

### Additional Hardware & Software Implementation Details

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto optical disks, or optical disks. However, a computer need not have such devices. Devices suitable for storing computer program instructions and information/data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back end component, e.g., as an information/data server, or that includes a middleware component, e.g., an application server, or that includes a front end component, e.g., a client computer having a graphical user interface or a web browser through which a user can interact with an implementation of the subject matter described herein, or any combination of one or more such back end, middleware, or front end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship with each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

In general, the method executed to implement the embodiments of the invention, may be implemented as part of an operating system or a specific application, component, program, object, module or sequence of instructions referred to as “computer program(s)” or “computer code(s).” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile (or non-transitory) memory devices, floppy and other removable disks, hard disk drives, optical disks, which include Compact Disk Read-Only Memory (CD ROMS), Digital Versatile Disks (DVDs), etc., as well as digital and analog communication media.

### CONCLUSIONS

One of ordinary skill in the art knows that the use cases, structures, schematics, flow diagrams, and steps may be performed in any order or sub-combination, while the inventive concept of the present invention remains without departing from the broader scope of the invention. Every embodiment may be unique, and step(s) of method(s) may be either shortened or lengthened, overlapped with other activities, postponed, delayed, and/or continued after a time gap, such that every active user and running application program is accommodated by the server(s) to practice the methods of the present invention.

For simplicity of explanation, the embodiments of the methods of this disclosure are depicted and described as a series of acts or steps. However, acts or steps in accordance with this disclosure can occur in various orders and/or concurrently, and with other acts or steps not presented and described herein. Furthermore, not all illustrated acts or steps may be required to implement the methods in accordance with the disclosed subject matter. In addition, those skilled in the art will understand and appreciate that the methods could alternatively be represented as a series of interrelated states via a state diagram or events or their equivalent.

As used herein, the singular forms “a,” “an,” and “the” include plural references unless the context clearly indicates otherwise. Thus, for example, reference to “a cable” includes a single cable as well as a bundle of two or more different cables, and the like. The terms “comprise,” “comprising,” “includes,” “including,” “have,” “having,” and the like, used in the specification and claims are meant to be open-ended and not restrictive, meaning “including but not limited to.”

In the foregoing description, numerous specific details are set forth, such as specific structures, dimensions, processes parameters, etc., to provide a thorough understanding of the present invention. The particular features, structures, materials, or characteristics may be combined in any suitable manner in one or more embodiments. The words “example,” “exemplary,” “illustrative” and the like, are used herein to mean serving as an example, instance, or illustration. Any aspect or design described herein as “example” or equivalents are not necessarily to be construed as preferred or advantageous over other aspects or designs. Rather, use of the words “example” or equivalents is intended to present concepts in a concrete fashion.

As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A, X includes B, or X includes both A and B, then “X includes A or B” is satisfied under any of the foregoing instances.

Reference throughout this specification to “an embodiment,” “certain embodiments,” or “one embodiment” means that a particular feature, structure, or characteristic described in connection with the embodiment is included in at least one embodiment. Thus, the appearances of the phrase “an embodiment,” “certain embodiments,” or “one embodiment” throughout this specification are not necessarily all referring to the same embodiment.

As used herein, the term “about” in connection with a measured quantity, refers to the normal variations in that measured quantity, as expected by one of ordinary skill in the art in making the measurement and exercising a level of care commensurate with the objective of measurement and the precision of the measuring equipment. For example, in some exemplary embodiments, the term “about” may include the recited number +/−10%, such that “about 10” would include from 9 to 11. In other exemplary embodiments, the term “about” may include the recited number +/−X%, where X is considered the normal variation in said measurement by one of ordinary skill in the art.

Features that are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom. Features of the transitory physical storage medium described may be incorporated into/used in a corresponding method and/or system, and vice versa.

Although the present invention has been described with reference to specific exemplary embodiments, it will be evident that the various modifications and changes can be made to these embodiments without departing from the broader scope of the invention. Accordingly, the specification and drawings are to be regarded in an illustrative sense rather than in a restrictive sense. It will also be apparent to the skilled artisan that the embodiments described above are specific examples of a single broader invention which may have greater scope than any of the singular descriptions taught. There may be many alterations made in the descriptions without departing from the scope of the present invention, as defined by the claims.

What is claimed is:

1. A computer-implemented method for generating a set of recommended steps for concern resolution, comprising:
collecting a plurality of conversations between customers and human agents, wherein each conversation in the plurality of conversations between customers and human agents comprises at least one concern, at least one agent utterance, and at least one resolution step;
training a sequence-to-sequence transformer-based system on the plurality of conversations between customers and human agents to build a concern-resolution steps knowledge base, wherein the sequence-to-sequence transformer-based system comprises a bidirectional encoder and an autoregressive decoder, and receives a conversation as input;
receiving a human agent input through a human agent interface;
generating the set of recommended steps for concern resolution based on the human agent input, wherein the set of recommended steps for concern resolution is retrieved from the concern-resolution steps knowledge base; and
using a retrieve-rerank process to generate the set of recommended steps for concern resolution, wherein the retrieve-rerank process comprises:
embedding the human agent input to generate an embedding of the human agent input;
embedding a first plurality of resolution steps in the concern-resolution steps knowledge base to generate a first plurality of embeddings of resolution steps;
determining a cosine-similarity score between each embedding of resolution steps in the first plurality of embeddings of resolution steps and the embedding of the human agent input to generate a first plurality of cosine-similarity scores;
determining a plurality of closest resolution steps based on the highest cosine-similarity scores in the plurality of cosine-similarity scores, wherein the plurality of closest resolution steps correspond to a second plurality of embeddings of resolution steps in the first plurality of embeddings of resolution steps;
embedding a first plurality of concerns in the concern-resolution steps knowledge base to generate a first plurality of embeddings of concerns;
determining a cosine-similarity score between each embedding of concerns in the first plurality of embeddings of concerns and the embedding of the human agent input to generate a second plurality of cosine-similarity scores; and
reranking the plurality of closest resolution steps to generate the set of recommended steps for concern resolution, wherein reranking the plurality of closest resolution steps is based on the second plurality of cosine-similarity scores.

2. The computer-implemented method of claim 1, further comprising:
integrating a set of frequently asked questions (FAQs) and answers into the concern-resolution steps knowledge base; and
providing the knowledge base for search by a human agent to search through past resolutions to any customer concern that is input as a query.

3. The computer-implemented method of claim 1, wherein training the sequence-to-sequence transformer-based system comprises fine-tuning based on a plurality of extracted concerns from the plurality of conversations.

4. The computer-implemented method of claim 1, further comprising:
extracting the at least one concern from a conversation in the plurality of conversations between customers and human agents using the sequence-to-sequence transformer-based system to generate an extracted concern;
extracting the at least one agent utterance from the conversation in the plurality of conversations between customers and human agents using the sequence-to-sequence transformer-based system to generate an extracted utterance;
extracting the at least one resolution step from the conversation in the plurality of conversations between customers and human agents using the sequence-to-sequence transformer-based system to generate an extracted resolution step; and
storing a database entry comprising the extracted concern, the extracted utterance, and the extracted resolution step into the concern-resolution steps knowledge base.

5. The computer-implemented method of claim 1, further comprising:
displaying official company internal documentation articles to the human agent; and
preparing a knowledge base of each summarized article and corresponding embeddings.

6. The computer-implemented method of claim 1, further comprising:
generating a plurality of head entities from the concern-resolution steps knowledge base using a head topic and subtopic detection module;
determining a plurality of closest head entities from the plurality of head entities corresponding to the set of recommended steps for concern resolution based on measuring the match between each head entity in the plurality of head entities with each recommended step for concern resolution in the set of recommended steps for concern resolution;
receiving, by the bidirectional encoder, the set of recommended steps for concern resolution and the plurality of closest head entities from the plurality of head entities corresponding to the set of recommended steps; and
generating, by the bidirectional encoder, a plurality of subtopics associated with the plurality of closest head entities, wherein the plurality of subtopics is correlated with the set of recommended steps for concern resolution, and wherein a correlation between the plurality of subtopics and the set of recommended steps for concern resolution is based on a semantic cosine similarity.

7. The computer-implemented method of claim 1, wherein generating the set of recommended steps for concern resolution based on the human agent input uses a concern model, wherein the concern model comprises a conversation truncation module, a transformer, a concern-resolution steps knowledge base, and an encoder-decoder module, and wherein the concern model is configured to be trained by minimizing the cross-entropy loss.

8. The computer-implemented method of claim 1, further comprising:
using a head topic detection system to obtain answers; and
passing the answers through a hierarchical clustering algorithm that uses the word level edit distance between the spans as a distance metric.

9. The computer-implemented method of claim 1, further comprising:
using a zero-shot-NLI (natural language inference) classifier to detect the entity that represents the main entity in the concern;
performing a semantic cosine similarity of the concern and the centroid embedding of the sub-topics; and
identifying a closest sub-topic above a threshold within the head topic to which the concern belongs.

10. A non-transitory storage media storing program code, the program code executable by a hardware processor, the program code when executed by the hardware processor causing the hardware processor to execute a computer-implemented method for generating automated recommended steps for concern resolution, the program code comprising code to:
collect a plurality of conversations between customers and human agents, wherein each conversation in the plurality of conversations between customers and human agents comprises at least one concern, at least one agent utterance, and at least one resolution step;
train a sequence-to-sequence transformer-based system on the plurality of conversations between customers and human agents to build a concern-resolution steps knowledge base, wherein the sequence-to-sequence transformer-based system comprises a bidirectional encoder and an autoregressive decoder, and receives a conversation as input;
receive a human agent input through a human agent interface;
generate the set of recommended steps for concern resolution based on the human agent input, wherein the set of recommended steps for concern resolution is retrieved from the concern-resolution steps knowledge base; and
execute a retrieve-rerank process to generate the set of recommended steps for concern resolution, wherein the retrieve-rerank process comprises program code to:
embed the human agent input to generate an embedding of the human agent input;
embed a first plurality of resolution steps in the concern-resolution steps knowledge base to generate a first plurality of embeddings of resolution steps;
determine a cosine-similarity score between each embedding of resolution steps in the first plurality of embeddings of resolution steps and the embedding of the human agent input to generate a first plurality of cosine-similarity scores;
determine a plurality of closest resolution steps based on the highest cosine-similarity scores in the plurality of cosine-similarity scores, wherein the plurality of closest resolution steps correspond to a second plurality of embeddings of resolution steps in the first plurality of embeddings of resolution steps;
embed a first plurality of concerns in the concern-resolution steps knowledge base to generate a first plurality of embeddings of concerns;
determine a cosine-similarity score between each embedding of concerns in the first plurality of embeddings of concerns and the embedding of the human agent input to generate a second plurality of cosine-similarity scores; and
rerank the plurality of closest resolution steps to generate the set of recommended steps for concern resolution, wherein reranking the plurality of closest resolution steps is based on the second plurality of cosine-similarity scores.

11. The non-transitory storage media of claim 10, further comprising program code to:
integrate a set of frequently asked questions (FAQs) and answers into the concern-resolution steps knowledge base; and
provide the knowledge base for search by a human agent to search through past resolutions to any customer concern that is input as a query.

12. The non-transitory storage media of claim 10, wherein the program code to train the sequence-to-sequence transformer-based system comprises program code to fine-tune based on a plurality of extracted concerns from the plurality of conversations.

13. The non-transitory storage media of claim 10, further comprising program code to:
extract the at least one concern from a conversation in the plurality of conversations between customers and human agents using the sequence-to-sequence transformer-based system to generate an extracted concern;
extract the at least one agent utterance from the conversation in the plurality of conversations between customers and human agents using the sequence-to-sequence transformer-based system to generate an extracted utterance;
extract the at least one resolution step from the conversation in the plurality of conversations between customers and human agents using the sequence-to-sequence transformer-based system to generate an extracted resolution step; and
store a database entry comprising the extracted concern, the extracted utterance, and the extracted resolution step into the concern-resolution steps knowledge base.

14. The non-transitory storage media of claim 10, further comprising program code to:
display official company internal documentation articles to the human agent; and
prepare a knowledge base of each summarized article and corresponding embeddings.

15. The non-transitory storage media of claim 10, further comprising program code to:
generate a plurality of head entities from the concern-resolution steps knowledge base using a head topic and subtopic detection module;
determine a plurality of closest head entities from the plurality of head entities corresponding to the set of recommended steps for concern resolution based on measuring the match between each head entity in the plurality of head entities with each recommended step for concern resolution in the set of recommended steps for concern resolution;
receive, by the bidirectional encoder, the set of recommended steps for concern resolution and the plurality of closest head entities from the plurality of head entities corresponding to the set of recommended steps; and
generate, by the bidirectional encoder, a plurality of subtopics associated with the plurality of closest head entities, wherein the plurality of subtopics is correlated with the set of recommended steps for concern resolution, and wherein a correlation between the plurality of subtopics and the set of recommended steps for concern resolution is based on a semantic cosine similarity.

16. The non-transitory storage media of claim 10, wherein the generate the set of recommended steps for concern resolution based on the human agent input utilizes a concern model, wherein the concern model comprises a conversation truncation module, a transformer, a concern-resolution steps knowledge base, and an encoder-decoder module, and wherein the concern model is configured to be trained by minimizing a cross-entropy loss.

17. The non-transitory storage media of claim 10, further comprising program code to:
utilize a head topic detection system to obtain answers; and
pass the answers through a hierarchical clustering algorithm that uses the word level edit distance between the spans as a distance metric.

18. The non-transitory storage media of claim 10, further comprising program code to:
use a zero-shot-NLI (natural language inference) classifier to detect the entity that represents the main entity in the concern;
perform a semantic cosine similarity of the concern and the centroid embedding of the sub-topics; and
identify the closest sub-topic above a threshold within the head topic to which the concern belongs.
